(19) United States
(12) Patent Application Publication
(10) Pub. No.: US 2004/0156613 A1
(43) Pub. Date: Aug. 12, 2004

(54) Method and system for computer software application execution

(76) Inventors: Andrew Kosamir Henry Hempel, Potts Point (AU); Brendan Mark Norris, Melbourne (AU); Patrick Edward Ale, West Brunswick (AU); David Winter, Caulfield (AU); Martin Samuel Lipka, Ormond (AU); Robert Clark, Laburnum (AU)

Correspondence Address: HODGSON RUSS LLP, ONE M & T PLAZA, SUITE 2000, BUFFALO, NY, 14203-2391, US

(21) Appl. No.: 10/476,039

(22) PCT Filed: Jul. 5, 2002
(86) PCT No.: PCT/AU02/00922

(30) Foreign Application Priority Data
Jul. 6, 2001 (AU) PR 6200
May 9, 2002 (AU) PS 2213
Jun. 27, 2002 (AU) PS 3233

(51) Int. Cl. H04N 5/781

(52) U.S. Cl. 386/46; 386/125

(57) ABSTRACT

A method and system is disclosed herein for execution of a computer program in which multimedia presentations, such as full-screen broadcast quality video, can be provided on a user's computer. The computer program is arranged video content to decode/decompress associated media data and display the media content regrdless what video decoding and/or playback software may or may not be installed on the user's computer, thus enabling substantially universal access by user's to the multimedia presentations. The computer program and media data files may be distributed on the computer readable compact discs (CD-ROM's), for example, and the computer program is adapted to execute on the user's computer without requiring installation under the computer operating system. The media data files may be encoded such that a digital key or the like is required in order in order to decode the media data for playback, such that a media data file may only be played using a specific version of the program, or by provision of the digital key by way of user input or through a digital communications network such as the internet or a corporate intranet.

### FIELD OF THE INVENTION

This invention relates to the execution of computer software applications, and in particular to software application execution on a computer independent of operating system environment constraints.

### BACKGROUND OF THE INVENTION

A typical general purpose computing system utilises several layers of control over the computing system resources in order to process information in response to commands from a computer user. For example, a basic input/output system (BIOS) provides a framework enabling an operating system (OS) to control the hardware components of the computer. The operating system, in turn, provides a framework enabling software applications to be executed on the computer using the computer hardware resources. Generally, a software application must be “installed” in the operating system to enable the operating system to allocate computer resources without conflict amongst various applications.

The operating system layer keeps record of the installed applications in a catalogue that holds information enabling the operating system to determine if a requested software application is installed and available, and points the operating system to instructions allowing the application to be executed. On a computer with a Microsoft Windows operating system, this catalogue information is contained in what is referred to as the “registry”. Essentially the registry is a central database that stores information relating to hardware, system settings and application configurations. Some of the entries in the registry are referred to as Dynamic Link Libraries, which represent links to actual program commands. When a software application is installed under the Windows operating system, the installation process typically includes commands that add specific files to the registry so that the software can be recognised and processed by the operating system at the time of execution.

In many computing environments, such as corporate computer networks and the like, systems and network administrators often desire to maintain a standard operating environment (SOE) amongst the numerous computers. For example, each computer would typically have the same operating system configuration and be provided with the same set of installed software applications. In this way, each of the numerous computers can be maintained in a stable set-up configuration, which is known to tie administrator enabling simplified troubleshooting procedures. The Windows operating system caters for this administration procedure by providing a security feature that allows system administrators to prevent ordinary computer users from modifying a SOE. One of the ways in which this is achieved is by preventing an ordinary computer user (i.e. a computer user without system administrator privileges) from modifying the operating system registry on the computer. Without the capability of modifying the system registry, in many cases the user is unable to ran previously uninstalled software because the operating system is unable to obtain instructions regarding the existence of the software and the location of the program code. The result is that the ordinary computer user is prevented from installing new software on the computer. In most cases this is what the system administrator desires—the maintenance of the known stable computer software and operating system configuration and the prevention of software installations made without the administrator's compliance. This avoids software instability problems from being introduced to the computer from user initiated software installations causing operating system conflicts with other applications, and similar problems which are known to occur.

A result of the computer administration practice described above is that a computer user may not be able to access certain files and programs without assistance from the system administrator. For example, if a computer user receives a file in a dam format requiring a computer program not installed on that computer, the user is unable to access the file without installing the program. Assuming the computer program is available for installation, the file cannot be accessed without the assistance of the system administrator.

Even for computer users not constrained by the Limitations of an enforced SOE, accessing new files can still cause significant difficulties. If the user's computer does not have the necessary software to access the desired file, that software must be installed. The installation can be a time consuming process, and may result in system instability. Therefore, it may be considered too much trouble to install the program if the software will not be used often and the file access is not crucial. Further, the required software may not even be easily or immediately available to the user for installation.

One of the fields in which the above described difficulties currently represent a significant impediment is in the distribution and presentation of multimedia data that may be provided to a user on a compact disk (CD) or the like.

### SUMMARY OF THE INVENTION

In accordance with the present invention, there is provided a method for providing multimedia presentation by way of a computer processing and display apparatus having a data reading device for reading data from a removable digital data storage carrier, such as an optical data storage disk or the like, wherein a removable data storage carrier is provided having stored thereon at least one multimedia content data file in a compressed format, together with computer program code for execution on the computer processing and display apparatus and adapted for decompression of the at least one multimedia content data file and presentation of the multimedia content on the computer processing and display apparatus, wherein the computer program code provided with the multimedia content data file on the removable data storage carrier includes a data decompression module adapted to decompress the associated multimedia content data file and a multimedia player module that receives decompressed data from the decompression module and presents corresponding multimedia content for output by way of the computer apparatus hardware, whereby the multimedia content of the associated data file is presented by the computer apparatus hardware through use of the computer program code upon insertion of the removable data storage carrier in the data reading device and execution of the computer program code, and wherein the decompression and player program code modules are executable on the computer processing and display apparatus without requiring installation with the computer operating system, the player program module adapted to effect presentation of the associated multimedia content without reference to the operating system registry.

Preferably the player program module interacts directly with the decompression module and the hardware abstraction layer (HAL) of the computer operating system.

In another implementation of the invention, the multimedia content data file, which may represent video footage such as a movie for example, is coded with a digital key or the like such that decompression/decoding and/or playing of the multimedia content is only possible with decompression and/or player program having a corresponding decoding key. The decoding key may be incorporated into the decompression/player program module(s) provided with the multimedia content data file, or may be provided separately for input by the user or by way of a computer communications network such as the internet or a corporate intranet, for example.

One application of the invention involves at least one compressed multimedia content data file, such as a movie, provided on a CD, DVD or the like together with the decompression/player program code which is executable on a computer apparatus without installation with the computer operating system. The at least one data file is encoded with a digital key such that decompression and playing of the multimedia, content is only possible using the decompression/player program code with the provision of a corresponding decode key. This allows the CD or DVD stored with the multimedia content to be distributed free of charge, for example, but only playable by the user upon provision of the decode key. The decode key may be made available to the user through an internet site, for example, contingent upon payment of a viewing fee which could be made by a credit card transaction or other suitable payment system. The decode key may be specific to a single data file or applicable to a plurality of data files. Furthermore, the player/decompression program code may be adapted to interpret the decode key as being applicable for a limited number of presentations of the multimedia content or for a limited time period. The decode key may also be operative only with the particular decompression/player program that is provided with the data file, such that the data file can only be played with the particular decompression/player software and with the provision of the decode key. Further, the player program may be constructed such that a decode key needs to be provided from an external source, such as an internet site, several times during the course of the data file content playback, which can facilitate prevention of the same key being used simultaneously for multiple playbacks at different sites.

The present invention also provides a computer readable, removable digital data storage carrier having stored thereon at least one multimedia content data file in a compressed format together with computer program code for execution on a computer processing and display apparatus to decompress the at least one multimedia content data file and present the multimedia content on the computer processing and display apparatus, wherein the computer program code provided with the multimedia content data file on the removable data storage carrier includes a data decompression module adapted to decompress the associated multimedia content data file and a multimedia player module that, during execution on the computer apparatus, receives decompressed data from the decompression module and presents corresponding multimedia content for output by way of the computer apparatus hardware, whereby the multimedia content of the associated data file is presented by the computer apparatus hardware through use of the computer program code upon insertion of the removable data storage carrier in the data reading device and execution of the computer program code, wherein the decompression and player program code modules are executable on the computer processing and display apparatus without requiring installation with the computer operating system and wherein the player program module is adapted to effect presentation of the associated multimedia content without reference to the operating system registry.

The present invention further provides a computer having multimedia presentation capabilities operating under control of an operating system, in combination with a computer program that is executable on said computer to provide a multimedia presentation using an associated encoded media data file without requiring installation of the computer program with the operating system, the computer program including a decompression program module for decompressing media data from the encoded media data file and a player program module that in use interacts directly with the decompression module and a hardware abstraction layer of the computer operating system in order to provide the multimedia content presentation, wherein the player program module is adapted to effect presentation of the associated multimedia content without reference to the operating system registry.

The computer program is preferably provided stored on a removable data storage carrier, such as an optical digital storage disk or the like, together with at least one associated encoded media data file.

In a preferred implementation of the invention, the multimedia presentation comprises substantially full-screen broadcast quality video.

The invention further provides a computer program in machine readable form and executable on a computer operating under control of an operating system, the computer program including a decoding program module for decoding media data from an associated encoded media data file, and a player program module for processing the decoded media data and controlling the computer to provide a video display presentation of the decoded media data, wherein the computer program is executable without requiring installation under the computer operating system, and the player program module is adapted to effect presentation of the media data without reference to the operating system registry.

The computer program executable modules and at least one encoded media data file are preferably stored for distribution on a removable digital data storage carrier, such as a computer readable compact disk or the like.

Other aspects and features of the various implementations of the present invention will become apparent from the following detailed description.

### BRIEF DESCRIPTION OF THE DRAWINGS

The invention is herein described, by way of example only, with reference to the accompanying drawings. With specific reference to the drawings in detail, it is stressed that the particulars shown are by way of example and for purposes of illustrative discussion of the preferred embodiments only, and are presented in the cause of providing what is believed to be the most useful and readily understood description of the principles and conceptual aspects of the invention. In this regard, no attempt is made to shown structural details of the invention in more detail than is necessary for a fundamental understanding of the invention, the description taken with the drawings making apparent to those skilled in the art how the several forms of the invention may be implemented or embodied in practice.

In the drawings:

FIG. 1 is a block diagram of functional components of a Windows computer environment arranged for playing video content according to a conventional method;

FIG. 2 is a functional block diagram of a computer system arranged to operate according to a first embodiment of the present invention;

FIG. 3 is a functional block diagram of a computer system arranged to operate according to a second embodiment of the invention;

FIG. 4 is a class diagram of software components utilised in implementation of an embodiment of the invention;

FIG. 5 is a flowchart diagram outlining the operating procedure of a first version of a media player according to an implementation of the invention,

FIG. 6 is a flowchart diagram outlining the operating procedure of a second version media player software program;

FIG. 7 is a flowchart diagram outlining the operating procedure of a third version media player software program; and

FIG. 8 is a flowchart diagram outlining the operating procedure of a fourth version media player software program.

### DETAILED DESCRIPTION OF THE PREFERRED EMBODIMENTS

The principles and operation of a method, system and computer software structure for computer software application execution according to the present invention may be better understood with reference to the drawings and accompanying description.

Before explaining at least one embodiment of the invention in detail, it is to be understood that the invention is not limited in its application to the details of construction and arrangement of the components set fort in the following description or illustrated in the accompanying drawings. The invention is capable of other embodiments or implementations or of being practiced or carried out in various ways which may not be specifically enumerated herein but can be readily ascertained from the explanation that is provided. Also, it is to be understood that the specific nomenclature, phraseology and terminology employed herein is for the purposes of description and to provide a thorough understanding of the embodiments, and should not be regarded as limiting.

For high quality video to appear to move smoothly it should be viewed at about 25 frames per second, or greater, and each frame of raw video data may be several hundred kilobytes in size. Thus, to present video for viewing so that it appears smoothly and of good image quality requires that the raw video data be provided to the displaying apparatus (e.g. a computer) at a very high rate. If that data is provided on a removable storage media such as a CD-ROM, the CD-ROM reader is required to read and convey the data to the computer processor at a high rate. Some CD-ROM readers are not capable of that performance, which is one of the reasons why video data is compressed before storage. Another reason is simply to enable a reasonable amount of video footage to be stored on such removable storage media. In uncompressed form, an 8-minute digital video may be 2000 MB. It must be compressed to less than 45 MB in order to fit onto a mini CD-ROM.

Compression of a video file is achieved using video compression software, which produces a file of reduced size suitable for storage. The video is recovered from the compressed file using decompression software. The compression and decompression software is often referred to by the acronym “codec”. The word codec is herein used to refer to the compression and decompression software components individually and collectively according to the context of the function required to be performed.

Once the video file is compressed and stored on a CD-ROM, for example, it is then necessary for the recipient user's computer to decompress the file for playback. Conventionally the recipient computer must be installed with the same codec software for decompression as was used for the compression process of a given video file in order to effect playback. There are many forms of video codes in use, and it is possible that a recipient's computer may not have the decompression codec required for a particular video file. Accordingly, at present although good compression/decompression software technologies are available, few computer have adequate video codecs installed. This is particularly the case in the corporate environment where there is general reluctance on the part of systems administrators to install non-work related software (such as video codecs) and where executives and staff arc prevented from installing their own software. In order to allow distribution and presentation of multimedia to a broad range of computer users, playback of video therein should therefore be possible regardless of whether or not the user's computer is installed with codec software.

A product incorporating an embodiment of the present invention comprises a removable data storage medium recorded with multimedia video data together with executable code enabling the video presentation to be displayed on a computer operating under the Windows™ operating system independent of any video codes and/or player software that may be installed. This embodiment of the invention comprises software that cam be included in a packet of digital information also containing compressed video that allows a recipient of the information packet to view the video without requiring the installation of any software on the recipient's computer. The software of the invention handles all the transactions that are normally handled by windows in such a way that the files in the packet can be viewed using decompression and video player programs without those programs requiring installation and registration with the operating system. The packet of information will generally contain an auto-run routine, a video codec, a video data file, and a media player program. The media player program is modified as compared to a conventional media player suited for Windows in that all calls made to the decode library are altered in such a way that, instead of accessing the operating system registry in order to access the decoding capabilities of the video codec (e.g. openDivX), the codes is called directly thereby bypassing the Windows system registry.

In one form of the invention, the packet of information is contained on a compact disk (CD-ROM), which may be a standard sized CD, a miniature CD or a business card shaped CD. Alternatively, the information packet may be provided to the recipient on some other form of removable storage media, or can be provided to the user through a computer communications network such as the internet or a corporate intranet, for example. A business card sized CD-ROM can store about 45 MB of data, which equates to around 8 minutes of video when compressed. This provides a useful media my which to distribute and present corporate promotional video and multimedia presentations, for example, which is one field of application of embodiments of the invention.

The software of the invention may also incorporate the implementation of an encryption mechanism, whereby only files encoded with an authorised compression/encoding process can be played by the user. This solution is broadly achieved using the following method. At the time of video production and encoding, the compression/encoding system generates a unique key that is encrypted and stored in the header of the video data file. This unique signature key requires a matching signature within the decoding and media playing software in order for the video file to be considered valid, and only then is playback of the video permitted. This can be used to prevent a user form attempting to play unauthorised video files, which have not been encoded with this unique key embedded in its header. In an extension of this method, the video file itself may be encrypted using the key prior to storage or transmission in the information packet. In essence, the video data file in the information packet must match the functional components (e.g. codec and media player) supplied with the video data in order for playback of the video to be permitted.

Another modification incorporates the implementation of a web-based “lock and key” mechanism. This mechanism allows and end user to request (purchase) a key from a service provider by way of the internet in order to unlock and enable the decoder and player software to operate. The key provided may be specific to the player software itself, or may be unique to a particular media file. The media accessible to the user once the key has been obtained may be one or more media files provided initially with the player software, or may be provided through a computer communications networks such as the internet or a corporate intranet, for example. In this way, a CD could be provided to a user having the media player software of the present invention together with several media files of which only a portion are viewable by the user without obtaining a key. The freely viewable files or file portions may constitute a preview of the material that is viewable with use of the key.

Basically, users are required to enter a digital ID code (“key”) to “unlock” the video content. Unique digital ID codes are distributed to users with the packaging or the like of the E-genie disk. Upon disk insertion, the E-genie player will begin playback of the video content, which will continue for a short period of time before the player program requests the user input the supplied digital key code. If a key code is entered by the user, the code is validated by consultation with an internet site storing a list of valid key code authorizations. A matching code “unlocks” the remaining video content and allows the video playback to continue, whereas no key code, or an invalid key code entered by the user, results in the E-genie video playback being suspended.

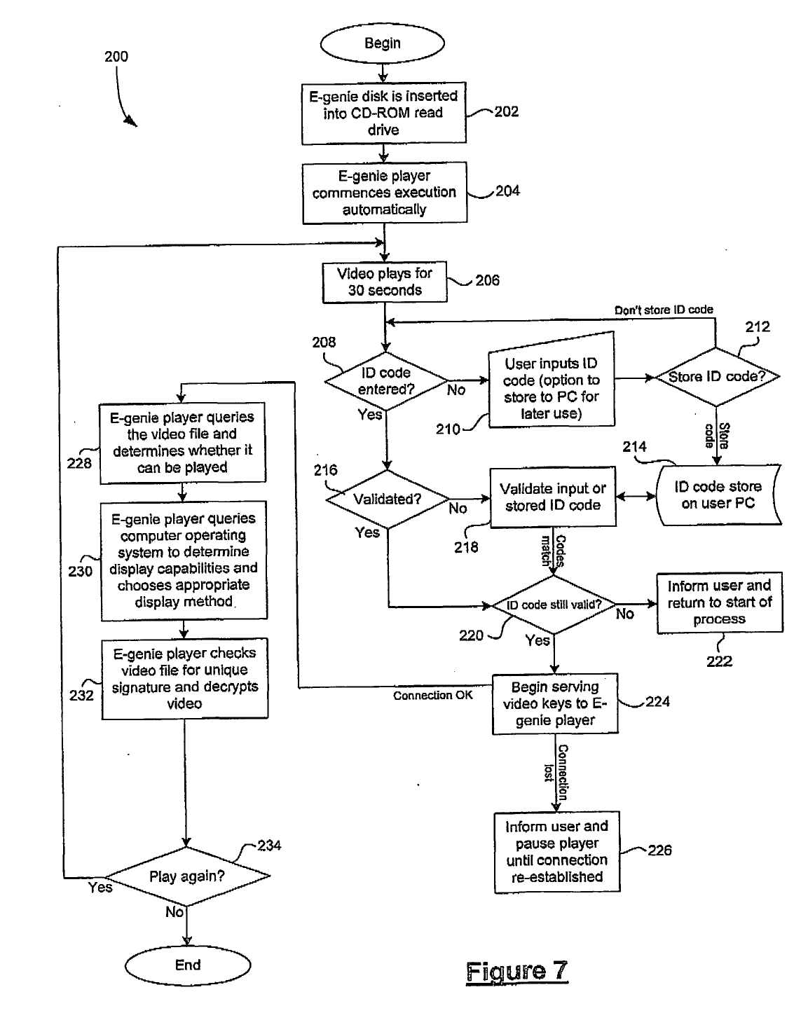

A procedure 200 including the lock an key functionality is illustrated in flow-diagram form in FIG. 7, and described briefly below. When the E-genie disk is inserted into a user's computer CD drive (202) the E-genic player commences execution automatically (204) and plays video for a short period of time, say 30 seconds (206). The initial time period for video playback can be set in the E-genie player program before distribution, or at the time video playback commences by way of instructions from an E-genie internet site. After commencement of the video playback, the player program requests input from the user of the ID key code supplied with the E-genie disk (208). The digital code may be printed on packaging provided with the disk, or may be supplied to the user by the S-genie supplier by any convenient alternative means. The user is offered the option for the code to be stored on the computer for later use (212, 214), to avoid the user having to enter the code repeatedly.

Upon a key code being entered by the user (210), the player program attempts to validate the supplied code through communication with an internet site that holds a record of valid code numbers (216, 218). The validation data stored at the internet site may include a correspondence between valid ID codes and codes embedded into the E-genie player software or content data, such that a match between such codes in respect of the user's playback instance is required in order to unlock the player for further video. In the event an invalid code or code correspondence is detected (216, 220), the user is informed of such occurrence at 222 whereupon the process restarts. A valid ED code detection (220) results in the E-genie internet server communicating with the E-genie player on the users computer so as to periodically supply video keys to the player program (224). Whilst the E-genie video plays, the user's ID code remains valid, and the user's computer remains in communication with the internet, the player program periodically (e.g. each 30 seconds or some other definable time period) receives a video key code from the internet server, which key is required by the player program in order for the video playback to continue for the next time period. If the user's internet connection to the internet server is lost, the user is informed of such event, and the video playback is paused (226) until the connection can be re-established for validation of the user ID and supply of the video key codes. So long as the appropriate video key codes are supplied to the player program, the process 200 continues through steps 228, 230, 232, 234, for example, which procedures are described in detail elsewhere in this document.

A specific implementation of an embodiment of the present invention is described hereinafter in the context of a Windows™ environment computing system, which is the most prevalent among home and business computer users presently. This embodiment is concerned with the presentation of multimedia to a recipient user on their computer without regard to specific video codecs and/or media players that may or may not be installed on the recipient computer. By way of background, the operations and functions involved in playback of video content in a standard Windows environment is briefly described hereinbelow.

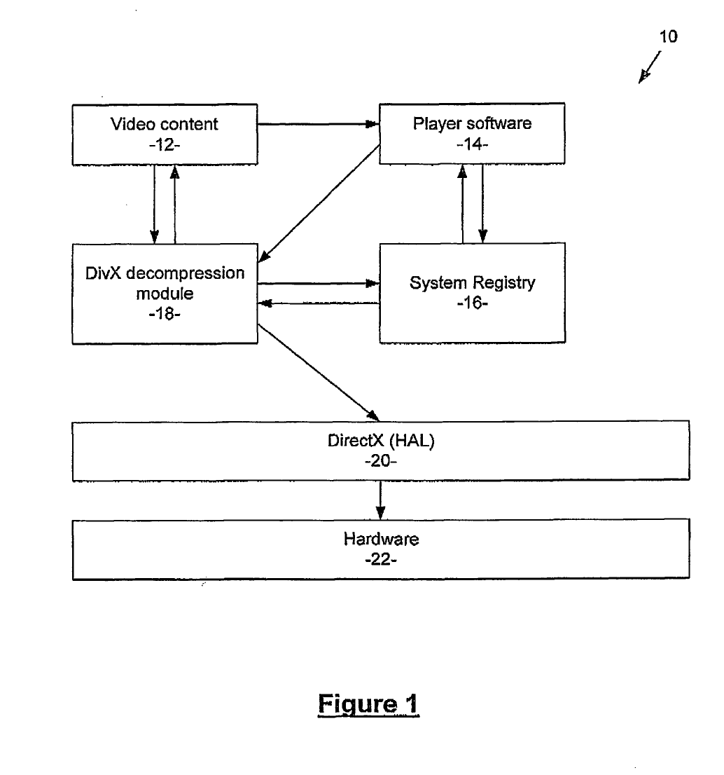

A block diagram of the functional components of a computer system 10 arranged for playing video content is shown in FIG. 1 and referred to hereinbelow in order to generally explain the operations involved in playing video content under a standard Windows environment. The video content data file is shown at 12 and may comprise, for example, a data file that represents a video clip in a compressed and encoded format. The video data is compressed and encoded for a number of reasons; one of-which is to enable a longer length video clip to fit on a given fixed capacity storage medium.

When the computer user requests that the video file 12 be played, a multimedia player program 14, which has been previously installed on the computer, is invoked with reference to the video file 12. The player software may comprise, for example, Windows Media Player, or the like. Having regard to information about the compression and encoding of the video file contained in the header thereof, for example, the player software queries the Windows System Registry 16 to determine if the computer has access to an appropriate decompression module. The system registry scans its entries for decompression software appropriate for the video file to identify a previously installed decompression module 18, such as DivX. The system registry then passes the decompression parameters for the valid decompression module back to the media player 14, and the player program instructs the decompressor to obtain video content data from the video file 12. Video content data is then passed from the video file 12 to the decompression module 18. The video data is decompressed/decoded and passed to the DirectX layer 20 of the Windows operating system. DirectX processes the decoded video data and passes video content to the computer hardware (22) whereupon it is displayed for the user.

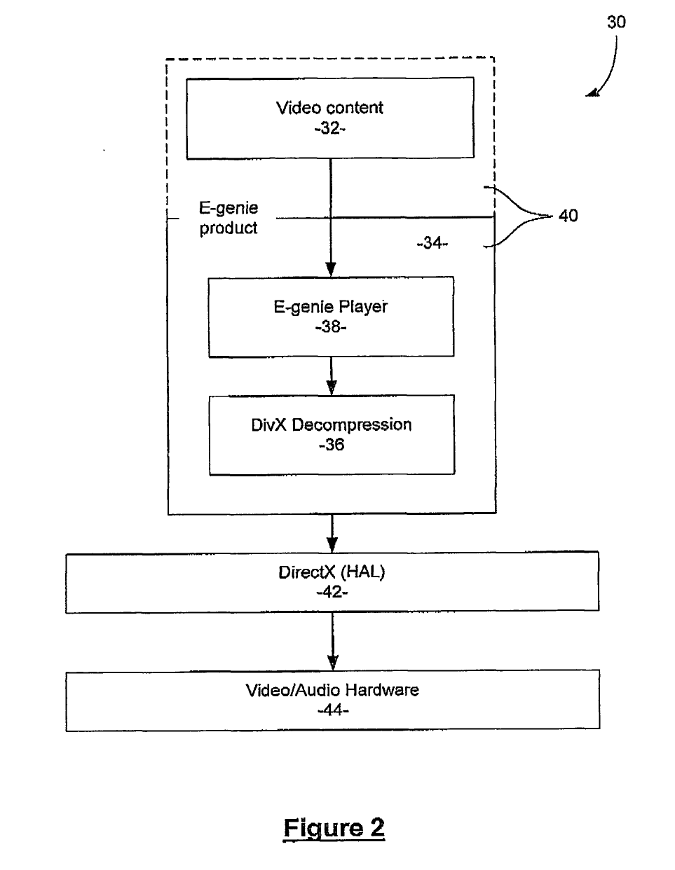

By way of contrast, FIG. 2 is a functional block diagram of a computer system 30 arranged to play video content according to an embodiment of the present invention, whereby the video content can be presented without requiring that the decompression and/or media player components needed to access the video file be previously entered in the Windows operating system registry. As can be seen in FIG. 2, the video content file (32) is passed to a media player and decompression software package, referred to herein as an Egenie™ (34). The Egenie software 34 includes decompression software, in this case modified open source code DivX decompression module 36, and video player software 38, such as a modified version of the Playa program which is a media player associated with openDivX. In one preferred form of the invention the video content file 32 and Egenie software 34 is contained together in an information packet 40, on a CD, DVD or other suitable digital media removable storage device.

Upon a request for presentation of the video content, data from the video file 32 is passed to the Egenie player 38, which may be invoked automatically upon insertion of the CD or the like into the computer drive, for example. The Egenie software is executed by the user's computer even though, as mentioned, it has not been installed and registered with the computers Windows operating system. The Egenie player interacts with the Egenie decompression module, whereby the video content data is processed to obtain decompressed video data. The decompressed video is passed from the Egenie software to the DirectX layer of the Windows operating system 42, which in turn presents the video data to the video/audio hardware of the computer for display to the user. The Egenie software is able to present the video footage from the video content file 32 on the user's computer regardless of whether that computer is installed with an appropriate media player or decompression software.

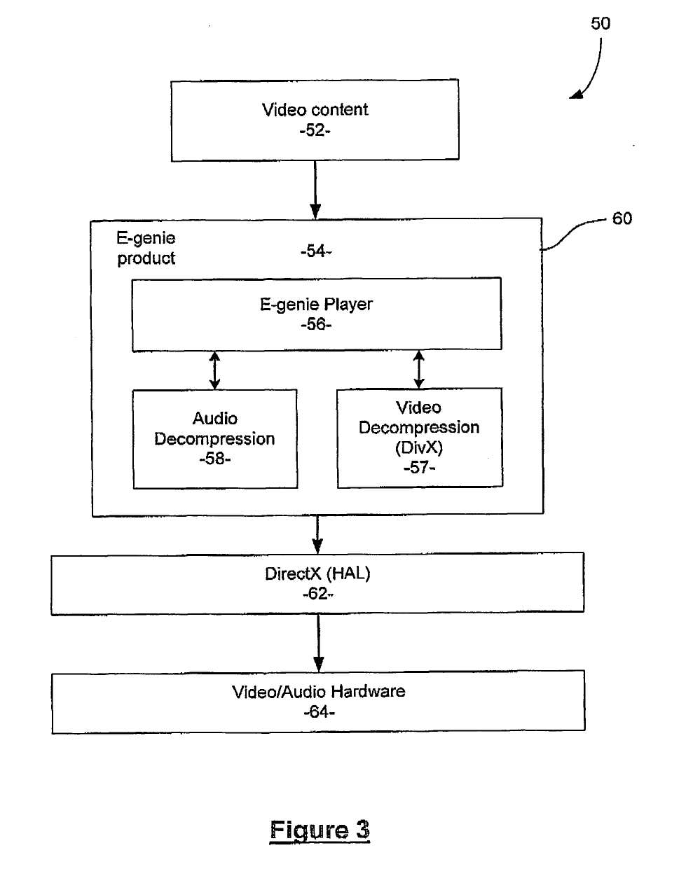

A functional block diagram of another computer system arrangement 50 is shown in FIG. 3, where reference numerals in common with the arrangement in FIG. 2 denote like components. The arrangement 50 illustrates a system in which the video content media data 32 is separate from the E-genie product 34 containing the media player 38, video codes 36, and in this case a separate audio codec 37.

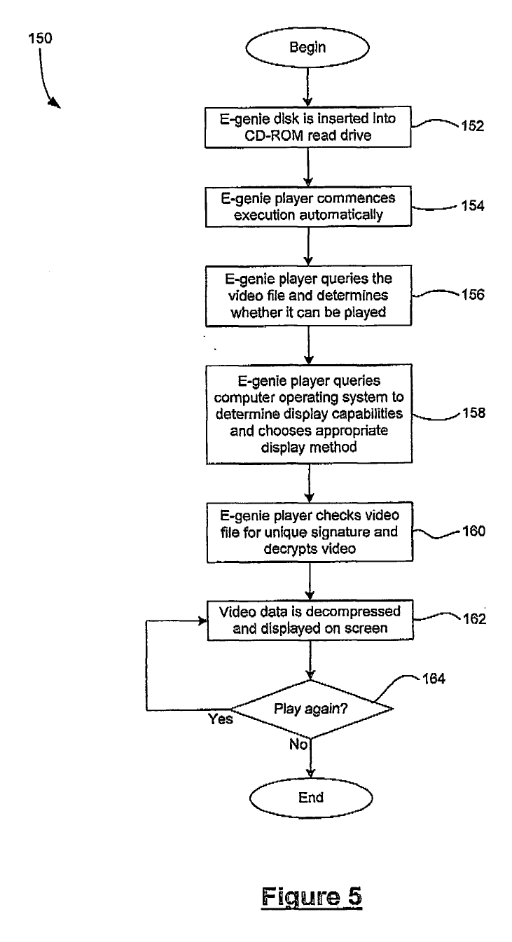

An outline of a first version of the E-genie player operational procedure 150 is depicted in flow-diagram form in FIG. 5. This version of the player operating procedure corresponds substantially to the functions as described hereinabove, beginning with the insertion of an genie disk into the CD-ROM drive of a personal computer or the like (152). The E-genie player software stored on the disk commences execution on the computer automatically (154) by examining the corresponding video data file to determine if it is in condition to be played (156). For example, the video data file may be scanned to ensure that the data available is complete and uncorrupted. The E-genie player program then queries the computer operating system to determine the display capabilities of the computer, in order to determine which of a plurality of display modes the player should utlise to make best effect of the computer resources whilst presenting a good video display to the user. The E-genie player selects the video display mode having the highest quality playback that is compatible with the resources of the computer (158). The E-genie player then proceeds to check that the relevant video data file contains a unique security signature indicating it is a valid and legitimate data file, and decrypts the video data from the file (160). The decrypted video data is then decompressed and presented for display on the computer screen for viewing by the user (162). Following completion of the playback, the user may indicate that the video should be played again (164). If not, the first version of the E-genie playback procedure 150 terminates.

Another advantageous feature of the present invention allows the E-genie player software to obtain user preference information. In this configuration, the E-genie software utilises an internet connection to provide user information to a central web-site. For example, at the end of video presentation, and optionally upon the user's request, the player forwards details of itself (Application name and path) to the website, by opening a browser window with the website's URL. This allows a website to generate scripts to execute different stored media files on the client machine, in response to selecting options on a web page. This permits a “broadband” web site experience on a relatively slow communications connection, such as a 56k dialup modem link to the internet The player is preferably also capable of detecting if an internet connection is present to enable such functions to be carried out.

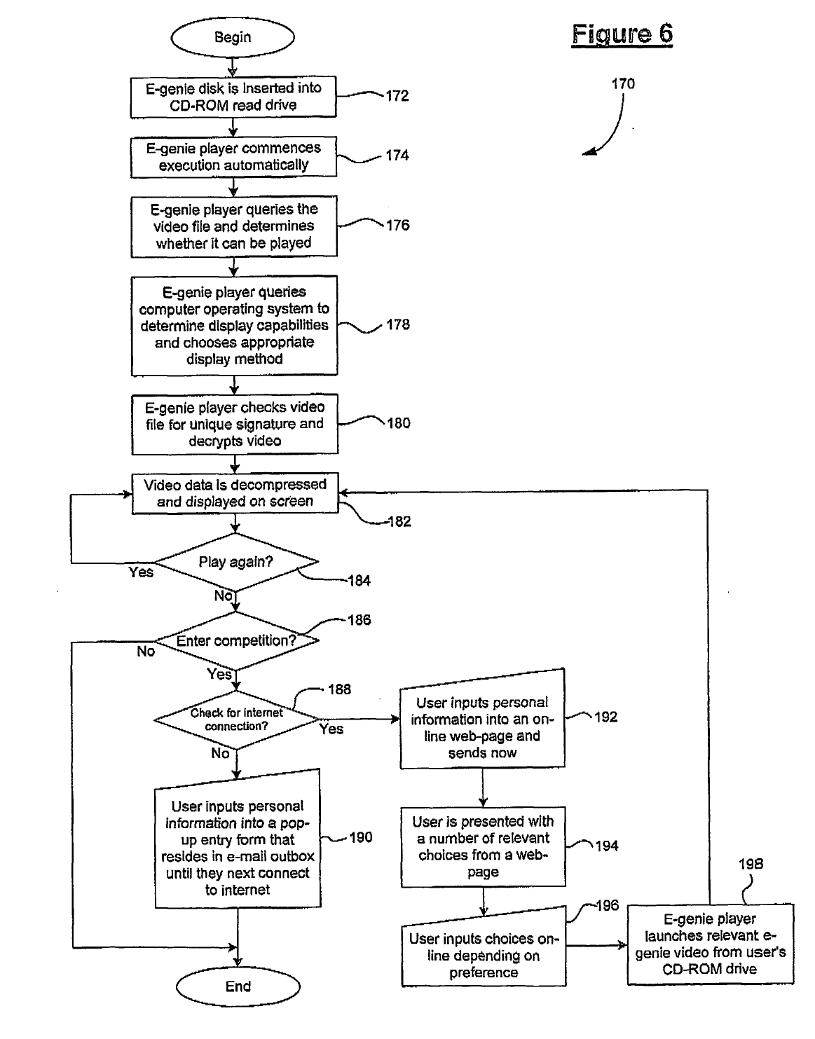

A procedure 170 according to a second version of the E-genie player operation is illustrated in flow-diagram form in FIG. 6, which includes the basic player functionality of procedure 150 with the addition of the web-hybrid function introduced above. In the web hybrid system 170, generally, the user is able to view a video display based on data contained on the E-genie disk, following which the user is offered a choice to “opt in” to view further video footage. If the user decides to opt in, a series of questions are asked of the user and from the gathered information a form of user profile is built and retained by the E-genie provider. Based on the information gathered, video data is selected as appropriate for that user profile, and the most relevant video content (referred to as the “derived” video content) is presented to the user by the E-genie player. The derived video content is preferably stored on the E-genie disk possessed by the user, but may not be otherwise accessible except through the opt in procedure.

Steps 172 to 180 of procedure 170 correspond to steps 152 to 160 of procedure 150 already discussed, and perform equivalent functions. Once the user is finished with viewing the displayed video content (84) the E-gene player presents the user with a choice of entering a competition or the like (186) in exchange for providing some personal information or survey answers (190, 192). If the user wishes to join he competition (186), the E-genie player software determines whether the computer has a connection to the internet (188). If an internet connection is found, the player software displays a questionnaire screen for completion by the user, which information is communicated immediately to the E-genie web-server (192). The user is then presented with a number of relevant choices from a web-page (194), to which the user provides choices on-line depending on preference (196). Upon completion, the E-genie player is provided with instructions or an unlocking code, for example, from the web-site which facilitates the player launching corresponding video from the E-genie disk in the user computer's CD-ROM drive.

In a variation of this system, feedback from the E-genie player can be provided by email. For example, at the end of video presentation, and optionally upon the user's request, the E-genie player software executes a sub-program which collects user information and populates an email with the details the user has entered (190). The user then selects to submit this form and next time their email client connects to send and/or receive messages the form is submitted to the server. A separate extraction program tool executing on the server scans the received emails and extracts the submitted data which can subsequently be used for targeted marketing and the like.

Another development of the E-genie software enables provision of a web interactive B-genie player, having a network communications connection of the player to a web server that is presenting and/or collecting information. The functionality is as follows. The player software connects to the web server via direct connection (opening a socket) and via query strings. The two contain a unique key that permits linking of web session and player instance. An E-genie software application on the server communicates with the web server, and sends commands to the E-genie player to present video selected by way of the web page.

A system of this form can be implemented using the following components:

1. E-genie Player.

The E-genie Player may function as follows. At the closing screen the player executes a web link, and hides in the background. The user is presented with the web page, and at the same time the player creates a direct connection to an application running on the web server. A unique number is generated, and passed by both query string and direct methods to enable the player to be “tied” to server.

2. Web Server

The web server communicates with the E-genie server application, as it requires to close the player, and to send it commands to present different footage.

3. E-genie Application on Web Server.

The E-genie server application communicates with the web server, and send commands to the B-genie player when requested. If it fails to deliver a command, an error is reported and the web server defaults to the existing batch file download and execute method. The server application also checks if the initial instance of the E-genie player is still alive.

4. Protocol.

A communications protocol to support the above system can be simple, containing error checking, correction, hijacking, spoofing and Denial of Service detection. It may also contain a flow of errors, if the player can't find a file, etc.

A further extension of the E-genie software involves augmenting the functionality of the network feedback and adding interactive components to the video footage. The extended network functionality is based on the web feedback mechanism described above, but supporting additional functionality as follows:

Creation of a web session at the start of the media playback by the E-genie player. This can be performed with or without the user details (i.e. anonymous or known user).

A direct (internet) connection passes back to The E-genie server application information on how the user is interacting with the video, based on what the user clicks, pauses, reviews, watches, etc;

Optional inclusion of User number information that allows Specific User preference information to be collected. (If completely anonymous or if user requested)

Advantageously, a user interface data stream may also be incorporated into the E-genie media data to be played by the E-genie player. The user interface stream facilitates the use of “clickable” areas in the video display. These video areas (when selected with the mouse) cause a function to occur. The function invoked for a particular application may comprise a video control (see below), and/or execution of a web page, program or other method of user feedback, or presentation to the user. Highlighted and non-highlighted version may be provided, wherein highlighting of the “clickable” display area emphasises to the user the inherent functionality but may detract from the visual appeal of some video presentations. The forms of video controls which may be useful for this type of function include: video playback pause/restart, frame rate control, reseeding control, resizing control, and/or various sound controls. In this implementation of the invention, it is intended that the video playback display create the entire user interface for the user to interact with and not just be a passive spectator.

In this embodiment, essentially, users are able to click on area of the video footage displayed by the E-genie player in order to instigate a response. The response may be in the form of the actions, mentioned by example only, such as: navigation to another location with in the video content being watched; overlaying information into the video stream so as to present intelligent advertising, user alerts, pricing information, retail product information, and the like.

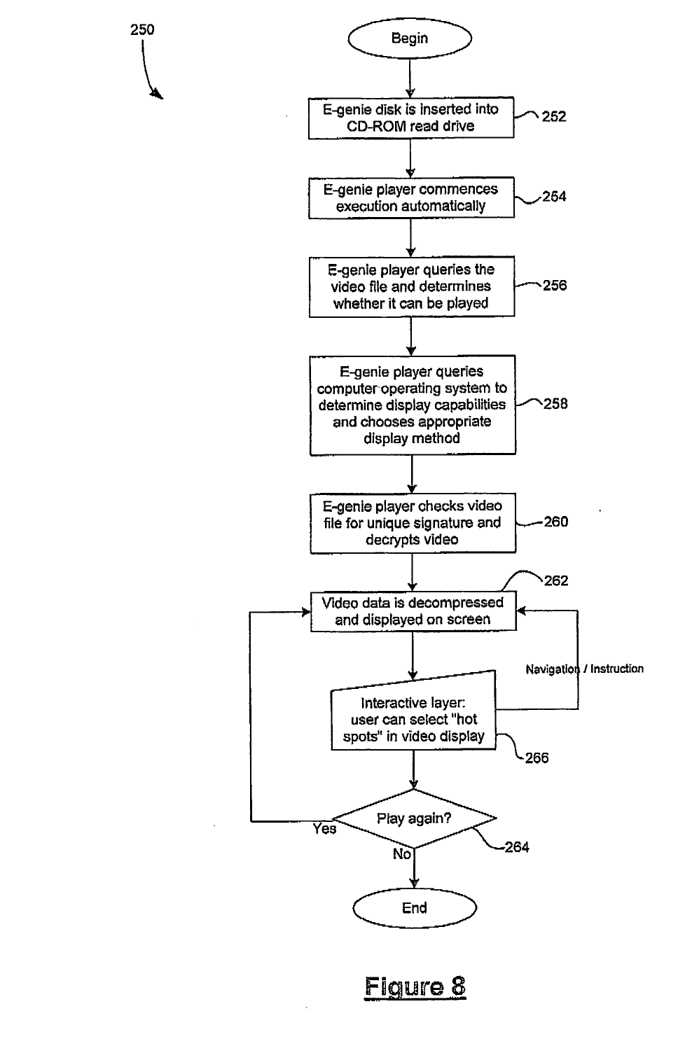

A procedure 250 according to a fourth version of the E-genie player operation is illustrated in flow-diagram form in FIG. 8, which includes the basic player functionality of procedure 150 with the addition of the video interaction function introduced above. The steps 252 to 264 shown in FIG. 8 correspond to steps 152 to 164 of procedure 150. The procedure 250, however, further includes a user interactive layer (266) that allows the user to actuate “hot-spots” provided in the video display using the computer mouse, for example. The hot-spot areas in the video display may be present for the duration of the video playback, or may be actuable by the user only during timed correspondence with the appearance of certain images of the video content. The E-genie player program detects the location and timing of the user's action to determine the function to be performed

A specific implementation of the invention as outlined above involves the use of the Microsoft Windows application programming interface (API) called DirectX, that provides an interface for access to the vast any of different types of hardware associated with Intel based personal computers (PCs). By using DirectX, an application programmer is able to code a computer program to work on all forms of PC hardware, without having to write individual code for each possible hardware device that might exist.

The E-genie implementation outlined above also makes use of the video codec called DivX, which is presently one of the best available systems for compressing and decompressing video files. The open source code version of DivX (openDivX) is utilised, modified as detailed below, in conjunction with the associated player referred to as Playa. The openDivX player is used to play video content that has been encoded by openDivX. It does this by using the decode library which utilises the openDivX decoding facilities, is decoded content is then displayed on the screen through the use of DirectX OpenDivX and DirectX typically use the Windows system registry in order to function, and thus the player has been altered for the purposes of the E-genie software so that it does not require access to the registry. In particular, all calls made to the decode library are modified in the E-genie player, so that instead of accessing the registry to access the decoding capabilities of openDivX, the openDivX decompression module is called directly hence bypassing the registry.

This particular implementation is designed for the presentation of high quality video on the Windows desktop where the user does not necessarily have We DivX codec installed on their PC. The method incorporates the digital video content, DivX decompression software and a video media player into a single file, that may be delivered on (but by no means limited to) a mini CD-ROM. In order for this methodology to work, the source code for the codec must be available, such that it can be incorporated into the E-genie file 40. There is no particular requirement that the codec used for the E-genie software be DivX, which was chosen simply because it facilitates high performance and the source code is available. In order to best take advantage of this method, the E-genie file 40 should also include a player, such that it is truly independent from all installed software.

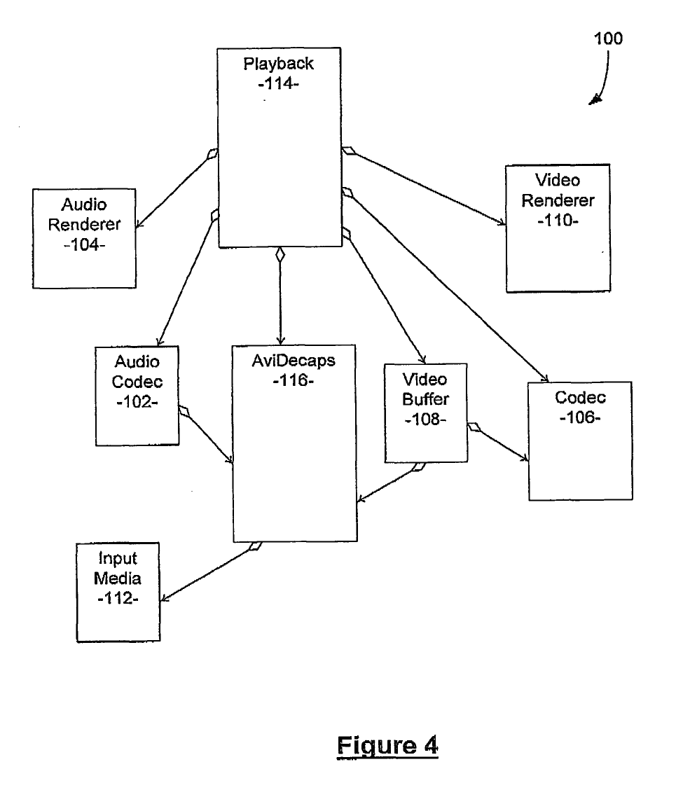

A class diagram 100 for the E-genie software implementation is illustrated in FIG. 4, and represents all of the classes and methods used to develop the E-genie software. The interconnecting lines between each class illustrate the relationships and dependencies between these classes, in situ, as they are implemented. The various classes, methods and data types employed are described in detail hereinafter.

Class Name:

AudioCodec

Description:

AudioCodec handles all the audio codec management of the Egenie Player. It is capable of playing mp3 encoded audio stream.

Attributes:

The Audio codec controls the included MP3 codec included with the Egenie player. It is responsible for getting compressed data from the AVI stream, and delivering decompressed data from the Audio codec to the AudioRenderer for generating audio output

| Structure for communicating with the mp3 decoder. | |
|---|---|
| struct mpstr | mp |
| Response from decompression codec. | |
| Int | last_result |
| int | mpeg |
| Amount fo data actually used/decrypted | |
| int | real_size |
| Windows internal structure for holding WAV type information. | |
| WAVEFORMATEX * | oFormat |
| Pointer to the location of the media source class | |
| AviDecaps * | decaps |
| Memory structure for compressed data | |
| Char * | in_buffer |
| Memory structure for decompressed data | |
| Char * | out_buffer |
| No remaining data to be read flag. | |
| bool | DepletedMP3Data |
| Milliseconds of time required to decode chunk of MP3 data. | |
| float | TotalTimeForOneSecond |

Methods:

| Method: | AudioCodec(AviDecaps *decaps, WAVEFORMATEX *lpWave) |
|---|---|
| Input: | AviDecaps *decaps, WAVEFORMATEX *lpWave |
| Output: | None |
| Description: | AudioCodec constructor. Initializes all needed variables. |
| Pseudocode: | Initialise mpeg variable |
| | Initialise in_buffer variable |
| | Initialise out_buffer variable |
| | Initialise oFormat variable |
| | Initialise last_result variable |
| | Initialise mp |
| | Mark Clock counter. |
| | If input lpWave = 1 |

assign input decaps to class attribute decaps
If lpWave's wFormatTag data member = 85

Initialise mp3
This−>last_result = MP3_NEED_MORE
Initialise ring buffer
Allocate memory to input buffer
Allocate memory to output buffer
If mp3 is decompressed correctly

close the mp3

end if
Write first chunk to output ring buffer.
/* Buffering */
while(ring isnt full)

keep decompressing
write to ring

end while
set DepletedMP3Data to false
set mpeg to 1
/* Set up the output format for the tenderer */
allocate new memory and copy lpWave
variable (oFormat)
copy lpWave into oFormat
setup oFormat variables exactly as lpWave
check if bits per Sample is 8 or 16, if neither, set to 16
check if channels is 1 or 2 if neither, set to 2

end if

| Method: | ˜AudioCodec( ) |
|---|---|
| Input: | None |
| Output: | None |
| Description: | AudioCodec Destructor. Cleans up memory associated with |
| | AudioCodec |
| Pseudocode: | Close( ) |
| | Safely delete input buffer |
| | Safely delete output buffer |
| | Safely delete format data. |
| Method: | BOOL IsOK( ) |
| Input: | None |
| Output: | None |
| Description: | Return TRUE is codec is ready to decompress |
| Pseudocode: | If this−>mpeg equals 1 |

Return TRUE

| | End if |
|---|---|
| Method: | Int EmptyBuffers( ) |
| Input: | None |
| Output: | Int |
| Description: | Empty all buffers |
| Pseudocode: | Initialise ring |
| | if its mpeg equals 1 |

this−>last_result equals MP3_NEED_MORE
exit the mp3
Initialise the mp3

| | End if |
|---|---|
| | Set DepletedMP3 to false. |
| | Refill the ring buffer with data, with while loop calling DecompressMP3. |
| | Write the decompressed Data to the Ring. |
| Method: | int DecompressMp3 ( ) |
| Input: | None |
| Output: | int |
| Description: | Returns the status of the read operation 1 is good 0 is bad. |
| Pseudocode: | if MP3 reading was ok by using last_result |

decode MP3 data and place result in last_result
If last_result was not need more data return 1
Attempt to read a chunck of compressed audio from AVIdecaps.
If full amount of data was returned,

Pass read data to decompression software,
Store return result in last_result
Return SUCCESS

Else

If no error was returned decode data.
Return success

End if

else

set variable ReadData equal to Result of ReadAudio
if ReadData is −1 return Error
if ReadData is 0 return 0
set last_result equal to result of call to decode MP3 codec.
Return Success

| | end if |
|---|---|
| Method: | Int Decompress(void *buffer, int size) |
| Input: | Void *buffer, int size |
| Output: | Int |
| Description: | decompress size octets of audio to buffer |
| Pseudocode: | if this is mpeg equals 1 |

if size equals 0 return 0

| declare variable - int blocks equals size/4096 | |
|---|---|
| loop until i equals than blocks | while |

ring not full and not DepletedMP3Data

if decompress mp3 equals 1

write to ring

else

| | |
|---|---|
| Set DepletedMP3Data to true | end if |

end while
ReturnedBytes equals result of read ring into buffer
If BytesReturned not equal to 4096, return BytesReturned
increment i

end loop

| | return 0 |
|---|---|
| Method: | Int Close( ) |
| Input: | None |
| Output: | Int |
| Description: | Closes the decoding engine |
| Pseudocode: | If its mpeg |

exit mp3
mpeg = 0

end if
return 1
Note:
The Ring Read and write functions are not described here, as it involves a simple FIFO ring buffer, with under and overrun protection.

Class Name:

AudioRenderer

Description:

AudioRenderer handles all the audio capabilities of the egenie player.

Attributes:

Variable for holding the volume.
VolumeAmount
Buffer handling variables for Direct Sound
g_dwBufferSize
g_dwLastPos
g_dwNextWriteOffset
g_dwProgress
g_dwProgressOffset
g_bFoundEnd
Handle to Audio Codec for obtaining Decompressed Data
ACodec
Variable to hold temporary division for data saving.
g_AudioTimeDivsor
Thread state variables
ThreadDead
WaitingThread
Paused state variable
IsPaused
Synchronising variables
LastPlayed
Tested
Volume Control Failure State
NoVolumeControl
Windows System Windows Variable
hWnd
Time between buffer updates
g_dwNotifyTime
Error handling variables
ErrorCode
ErrorMessage
Windows System variables for handling threads
AudioCallbackHandle
DirectSoundMutex
Device detection variables.
AudioDriverGUIDs
dwAudioDriverIndex
Direct Sound Interface variables
g_pDS
g_pDSBuffer
MediaStreamData

Methods:

| Method: | AudioRenderer(WAVEFORMATEX *inFormat, HWND hwnd) |
|---|---|
| Input: | volume |
| Output: | None |
| Description: | AudioRender constructor |
| Pseudocode: | Initialise g_pDS |
| | Initialise g_pDSBuffer |
| | Initialise ErrorCode |
| | Initialise ErrorMessage |
| | Initialise DirectSoundMutex |
| | Initialise ACodec |
| | Initialise WaitingThread |
| | Initialise ThreadDead |
| | Initialise dwAudioDriverIndex |
| | Initialise AudioCallbackHandle |
| | Initialise IsPaused |
| | Initialise LastPlayed |
| | Initialise Tested |
| | Initialise VolumeAmount to previous volume |
| | Initialise NoVolumeControl to false |
| | Initialise g_dwProgressOffset |
| Method: | ˜AudioRenderer( ) |
| Input: | None |
| Output: | None |
| Description: | Default Destructor. - used to be free direct Sound. |
| Pseudocode: | Call SafeExit |
| Method: | Void SafeExit(void) |
| Input: | None |
| Output: | None |
| Description: | Destroys all variables |
| Pseudocode: | If AudioThread exists |

if thread is not dead then set WaitingThread to 1
while Waiting for the Thread

sleep 10 milliseconds
increment counter
if counter equals 10 then call resume thread,

just in case it was paused.

If counter is greater that 20

Forcibly terminate thread
Break from loop

End If

End While

| | End if |
|---|---|
| | Destroy the Thread Handle |
| | Destroy the Mutex object |
| | Release DirectSound interfaces |
| | Release COM object |
| Method: | void HandleError(char * WindowTitle) |
| Input: | char * |
| Output: | void |
| Description: | This function advises the user of a fault, and then exits. |
| Pseudocode: | Call SafeExit |
| | Tell the user about the fault |
| Method: | int InitDirectSound( HWND hDlg , void * base, AudioCodec * |
| | Codec) |
| Input: | HWND, void *, AudioCodec * |
| Output: | Int |
| Description: | Initilises DirectSound |
| Pseudocode: | Initialise COM |
| | If fail return |
| | Enumerate Available Direct Sound Devices. |
| | If fail return |
| | If no drivers are available return a failure. |
| | Create IDirectSound using the primary sound device |
| | If fail return |
| | Set coop level to DSSCL_PRIORITY |
| | If fail return |
| | Set up variables for the primary buffer. |
| | Get the primary buffer |
| | If fail return |
| | Grab the primary sound buffer, and make our sound buffer always play |
| | If fail return |
| | Attempt to get the primary sound buffer for setting the audio mode |
| | If fail return |
| | Create the Mutex for accessing the direct sound. |
| | Check for mutex errors, if fail return. |
| | Create a thread to handle the audio callback. |
| | If fail return |
| | Set paused to true. |
| | Return successful. |
| Method: | int AudioRenderer::SetVolume(VolumeSet) |
| Input: | Enum Up or Down |
| Ouput: | Int |
| Description: | Increments or decrements the volume control on the users |
| | request. |
| Pseudocode: | If No Volume Control is available return |
| | If there is no buffer to control return |
| | If (volume is to increase) |

Set VolumeAmount = VolumeAmount + 200
If VolumeAmount is greater than max volume then

Set Volume to max

End if
Call Set volume
IF error then return 1
Return 0

End if
If (volume is to decrease)

Set VolumeAmount = VolumeAmount − 200
If VolumeAmount is less than min volume then

Set Volume to min

End if
Call Set volume
if error then return 1
Return 0

| | End if |
|---|---|
| Method: | int AudioRenderer::CreateStreamingBuffer(void) |
| Input: | void |
| Ouput: | int |
| Description: | Creates a streaming buffer, and the notification events to |
| | handle filling it as sound is played |
| Pseudocode: | This samples works by dividing a 132 k buffer into |
| | AUDIOBUFFERNOTIFYSEGMENTS (or 16) pieces. |
| | Set up a windows timer that works through the windows event handling function |
| | and calls the AudioCallback function. |
| | Set g_dwNotifyTime to ms of playing time per buffer segment |
| | Set g_AudioTimeDivsor to floating point calculation to prevent in loop |
| | calculations. |
| | Allocate a sound buffer descriptor |
| | Set the buffer to global focus, control volume and got current position2. |
| | Attempted to create the buffer. |
| | If failed |

If Error was DSERR_INVALIDPARAM

Presume DirectX2 was found.
Retry setting the parameters with get current position2
Call CreateBuffer
If error

Set variable structure size to magic number 20 (for

NT4)

Call Create Buffer
If error

Set to GetPos 2
Call Create Buffer
If error return fault

End if

End if

Else if

Return 1

End if

| | End if |
|---|---|
| | Set Volume of buffer |
| | If failed set no volume control to true. |
| | Return ok |
| Method: | int Play( BOOL bLooped) { |
| Input: | BOOL |
| Ouput: | Int |
| Description: | Play the DirectSound buffer |
| Pseudocode: | Check for prior error. If so exit |
| | Check for the existence of a buffer Create if necessary. |

Restore the buffers if they are lost

Fill the entire buffer with wave data
Always play with the LOOPING flag since the streaming buffer

If error return

| | wraps around before the entire WAV is played |
|---|---|
| | Start the thread processing. |
| | Set paused to false. |
| | Return ok |
| Method: | int AudioRenderer::FillBuffer( BOOL bLooped ) { |
| Input: | BOOL |
| Output: | int |
| Description: | Fills the DirectSound buffer with wave data |
| Pseudocode: | If prior error return. |
| | If no buffer return. |
| | Set buffer data flow measuring variables |
| | Set buffer position to start of buffer. |
| | Write Data into the buffer |
| | Return ok |
| Method: | int ReSeek( ) |
| Input: | SeekTime |
| Output: | Int |
| Description: | Empties audio Codec buffers and restarts at new time |
| Pseudocode: | If ErrorCode and it is not a DirectX stopped playing fault return error |
| | Wait 1 second to collect the mutex for the direct |
| | switch dwWaitResult |

Case Successful collection of the mutex.

If not paused, pasue, then if error return error.
Empty the buffers from the audiocodec.
Calculate the seek location. Store in

g_dwProgressOffset.

Call FillBuffer, if error return error.
Reset DirectX stopped playing variables, and continue.

CASE MutexUnavailable

Set Error
return error

end switch

| | Release Mutex. If error, set error and return error |
|---|---|
| | Return ok |
| Method: | Int WriteToBuffer( BOOL bLooped, DWORD |
| | dwBufferLength) |
| Input: | BOOL, DWORD |
| Output: | Int |
| Description: | Writes wave data to the streaming DirectSound buffer |
| Pseudocode: | Lock the buffer down, at the last written position. |
| | If !g_bFoundEnd |

Stuff the buffer regardless if paused or not
Grab data and copy to the streaming buffer

else

Fill the DirectSound buffer with silence
If the end of the wavefile has been located, just
stuff thebuffer with zeros
If the number of bytes written is less than the
amount we requested, we have a short file

| | end if |
|---|---|
| | Now unlock, the buffer |
| Method: | int Stop( ) |
| Input: | None |
| Output: | int |
| Description: | Stop the DirectSound buffer |
| Pseudocode: | If buffer exists |

Stop the buffer
If error, set error and return error
Set pasued

| | End if |
|---|---|
| Method: | DWORD WINAPI AudioCallback( LPVOID TAudioRenderer) |
| Input: | LPVOID |
| Output: | DWORD |
| Description: | Handle the notification that tell us to put more wav data in the |
| | circular buffer |
| Pseudocode: | If thread is requested to continue |

Wait for the sound buffer to be available to talk to (infinitely).
Locate the current buffer position.
Check for buffer wrap around for empty buffer space calculation.
If there enough space to write data into buffer,

Write To Data Buffer
If error record error and exit thread.
Update progress.
Release Mutex
If Error return error and exit thread
Sleep 5 milliseconds.

Else If

Release Mutex
If Error return error and exit thread
Sleep (Notify time)

End if

| | End if |
|---|---|
| | Exit Thread cleanly |
| Method: | int AudioRenderer::RestoreBuffers( BOOL bLooped ) |
| Input: | BOOL |
| Output: | int |
| Description: | Restore lost buffers and fill them up with sound if possible |
| Pseudocode: | Check if direct sound object exists. If not return. |
| | Get the status of the buffer - This checks if the buffer is available for |
| | usage. |
| | If fault record error and return error. |
| | If buffer is lost |

Attempt to restore ad infiniteum, if the buffer is still lost
Fill the buffer

| | End if |
|---|---|
| | Return ok |
| Method: | int Pause( ) |
| Input: | None |
| Output: | Int Status |
| Description: | Pause the Direct Sound Buffer |
| Pseudocode: | If buffer doesn't exit return ok |
| | If Mutex doesn't exist return ok |
| | If is already paused, return ok |
| | Set paused to true. |
| | Wait 1 second to collect the mutex for the direct sound interface. |
| | switch depending on dwWaitResult |

CASE: Successful collection of the mutex.

Call Stop Buffer
If Error record error and return error

CASE:Cannot get mutex object ownership due to time-out

Record Error and Return Error.

| | End switch |
|---|---|
| | Release Mutex. |
| | If Error record error and return error |
| | Return ok |
| Method: | int Resume( ) |
| Input: | None |
| Output: | Int Status |
| Description: | Resume the Direct Sound Buffer |
| Pseudocode: | If buffer doesn't exit return ok |
| | If Mutex doesn't exist return ok |
| | If is already paused, return ok |
| | Set paused to false. |
| | Wait 1 second to collect the mutex for the direct sound interface. |
| | switch depending on dwWaitResult |

CASE: Successful collection of the mutex.

Call Play Buffer
If Error record error and return error

CASE:Cannot get mutex object ownership due to time-out

Record Error and Return Error.

| | End switch |
|---|---|
| | Release Mutex. |
| | If Error record error and return error |
| | Return ok |
| Method: | BOOL AtEnd(void) |
| Input: | void |
| Output: | BOOL |
| Description: | Return the status of the AudioRenderer (Has it run out of data) |
| | This is to ovecome global optimisations, That allocate the g_bFoundEnd to be |
| | local. |
| Pseudocode: | return g_bFoundEnd |
| Method: | Int ThreadHealthy( ) |
| Input: | None |
| Output: | Int |
| Description: | Works out if thread is dead |
| Pseudocode: | If error is DirectX stopped playing return StoppedPlaying |
| | if Thread is Dead |

return yes

| | end if |
|---|---|
| | return no |
| Method: | DWORD PlayedTime( ) |
| Input: | None |
| Output: | DWORD |
| Description: | Return number of milliseconds played, and checks if DirectX |
| | is playing when requested to. |
| Pseudocode: | If tested is negative, then set to initial value of get tick count |
| | Get Current Buffer position. |
| | If Error, Set Error and return Error. |
| | Calculate the milliseconds. |

Milliseconds = ((g_dwProgress− dwPlayPos))/g_wBufferSize)

*g_dwBufferSize+g_dwProgressOffset+dwPlayPos) /
g_AudioTimeDivsor)

if not paused and Milliseconds is less than Last Played

if greater than half a second behind, set fault to playback not

running.
else if

Update timing variables

| | end if |
|---|---|
| | end if |
| | if Milliseconds = 0 Milliseconds++ (divide by zero faults) |
| | return Milliseconds |
| Method: | BOOL CALLBACK DSoundEnumCallback( GUID* pGUID, |
| | LPSTR strDesc, LPSTR strDrvName, VOID* pContext ) |
| Input: | None |
| Output: | BOOL |
| Description: | Enumerates all available Direct Sound devices for playback. |
| Pseudocode: | Record GUID details and return |

Class Name:

Codec

Attributes:

Width of the decompressed frame

unsigned int stride

For the DIVX codec

| | |
|---|---|
| DEC_SET | dec_set |
| DEC_PARAM | dec_param |
| DEC_FRAME | dec_fram |
| DEC_MEM_REQS | dec_mem |
| Type of decompression rendering from the codec | |
| VideoDecodeFormatType | videoMode |

Is ok flag

| | |
|---|---|
| DWORD | divx |

Methods:

| Method: | Codec(BITMAPINFOHEADER *bih, VideoDecodeFormatType |
|---|---|
| | BitsPerPixelMode) |
| Input: | BITMAPINFOHEADER *bih, int BitsPerPixel |
| Output: | None |
| Description: | Codec constructor. Initialises all member attributes of Codec |
| | Class |
| Pseudocode: | Set ErrorCode to none |
| | Set divx to false |
| | Set videoMode = NOT DEFINED |
| | Set Memory Buffers to NULL |
| | if bih exists |

if bih has a biCompression attribute that is equivalent to 4

bih−>biCompression equals mmioFOURCC(‘D’, ‘I’, ‘V’, ‘X’)

end if
if bih−>biCompression equals mmioFOURCC(‘D’, ‘I’, ‘V’, ‘X’)

set dec_param.x_dim equals to bih−>biWidth
set dec_param.y_dim equals to bih−>biHeight
set dec_param.output_format equal BitsPerPixelMode
set videoMode to same
Set dec_param.time_incr equal to 15
call the decore and request the size of required memory

structures.

Set stride = width of bitmap.

Allocate memory according to size requested by Decore.
If memory doesn't allocate exit
Clear all the memory allocated.
Call and Initialise the decore.
Set the post processing filter level to 100.
Call the decore and set this parameter
Set DivX to one.

End if

| | End if |
|---|---|
| Method: | ˜Codec( ) |
| Input: | None |
| Output: | None |
| Description: | Deletes and frees up all memory used by the Codec Class |
| Pseudocode: | Call Close |
| Method: | Int IsOK( ) |
| Input: | Int |
| Output: | None |
| Description: | Checks whether the codec was successful |
| Pseudocode: | if divx is not equal to 0 |

Return true

| | End if |
|---|---|
| Method: | int GetVideoMode( ) |
| Input: | None |
| Output: | Int |
| Description: | Gets the video mode |
| Pseudocode: | return videoMode |
| Method: | char *GetCodecName( ) |
| Input: | None |
| Output: | char * |
| Description: | Returns codec name |
| Pseudocode: | If its divx |

return “Egenie OpenDivX video codec”

| | end if |
|---|---|
| | return NULL |
| Method: | int Close( ) |
| Input: | None |
| Output: | Int ok |
| Description: | Deletes all the memory allocated to the codec. |
| Pseudocode: | If its divx = 1 |

Call the decore and tell it to release.

| | Deallocate all memory allocated for the codec. |
|---|---|
| Method: | int Decompress(char *in, long in_size, char *out) |
| Input: | char *in, long in_size, char *out |
| Output: | Int |
| Description: | Decompress frame |
| Pseudocode: | If its divx = 1 |

| dec_frame.length equals in_size | |
|---|---|
| dec_frame.bitstream equals in | |
| dec_frame.bmp | equals out |
| dec_frame.stride | equals stride |

dec_frame.render_flag equals 1

decore(according to dec_param just setup)

| | end if |
|---|---|
| | return 0 |
| Method: | int Drop(char *in, long in_size, char *out) |
| Input: | char *in, long in_size, char * out |
| Output: | Int |
| Description: | Drop frames |
| Pseudocode: | If its divx = 1 |

| dec_frame.length equals in_size | |
|---|---|
| dec_frame.bitstream equals in | |
| dec_frame.bmp equals out | |
| dec_frame.stride | equals stride |

dec_frame.render_flag equals 0

decore(according to dec_param just setup)

| | end if |
|---|---|
| | return 1 |
| Method: | void HandleError( ) |
| Input: | WindowTitle |
| Output: | int |
| Description: | Reports and error to the user (safely) |
| Pseudocode: | Call Close |
| | Print The Error String |
| | Report Error to the user. |
| Method: | int SetPostProcessorLevel (int Percentage) |
| Input: | Percentage |
| Output: | int |
| Description: | Sets the amount of post processing filtering |
| Pseudocode: | Set dec_set.postproc_level to input Percentage |
| | Call the decore with the new settings |
| | Return ok |

Class Name:

VideoBuffer

Description:

Creates a buffer, which stores decompressed frames.

Attributes:

Pointer to the decaps structure that returns the file stream.
decaps
Pointer to the decoding class that decompresses the file stream.
codec
Temporary frame buffer storage array.
frames[BUFFER_SIZE]
A temporary buffer storage for the input stream.
input_buffer
Number of free frames left in the videobuffer
free_slots
Size of the frame in the frame buffer
frame_size
The status of the frames in the buffer.
frame_buffer_status
The time taken to buffer 5 frames
TotalTimeFor5Frames
Error Checking/Reporting.
ErrorCode
ErrorMessage

Methods:

| Method: | VideoBuffer(AviDecaps *decaps, Codec *codec) |
|---|---|
| Input: | AviDecaps *decaps, Codec *codec |
| Output: | None |
| Description: | VideoBuffer Class constructor |
| Pseudocode: | Set input_buffer to NULL |
| | Set decaps to decaps. |
| | Set codec to codec. |
| | Set free_slots to number available. |
| | Clear the error settings. |
| Method: | ˜VideoBuffer( ) |
| Input: | None |
| Output: | None |
| Description: | VideoBuffer destructor class, frees all memory used by |
| | VideoBuffer |
| Pseudocode: | Call Stop |
| Method: | Initialise(int BitsPerPixelMode) |
| Input: | Bits per pixel Mode |
| Output: | int |
| Description: | Sets up the frame buffers, |
| Pseudocode: | If no codec or no decaps return error |
| | Allocate memory for the input_buffer |
| | If fail, return |
| | Clear input_buffer memory. |
| | Allocate memory for the frame_buffer_status |
| | If fail, return |
| | Clear frame_buffer_status memory. |
| | Calculate frame memory size from width height and bits per pixel, |
| | Loop while frames to be created exist |

Allocate memory for the frame_buffer
If fail, return
Clear frame_buffer memory.
Set tag to empty frame

| | End loop |
|---|---|
| | Return ok |
| Method: | int Start( ) |
| Input: | None |
| Output: | None |
| Description: | Starts the process frame storing process. |
| Pseudocode: | Store start time for processing |
| | Fill all the frame buffers, by calling GiveMeAFrame. |
| | Stop timing and record time taken to process a frame. |
| | Set free_slots to fall |
| | Return ok |
| Method: | void Stop( ) |
| Input: | None |
| Output: | None |
| Description: | Deallocates the input buffers and frame buffers |
| Pseudocode: | Safely destroy the input buffer |
| | Safely destroy all the frame buffers. |
| Method: | Char *GiveMeAFrame( ) |
| Input: | Frame and Buffer Number. |
| Output: | Int |
| Description: | Returns a decompressed frame |
| Pseudocode: | Check if a buffer is available. |
| | If so |

Set it status to played.
Set Frame to the Frame
Return ok

| | End if |
|---|---|
| | Call the decaps to get data for next video frame. |
| | If last frame, set frame to nothing and return ok |
| | If decaps error, set error and frame to nothing, return error. |
| | Call the codec to decompress the frame. |
| | If error, set error, and return error |
| | Set Frame equal to the decoded frame |
| | Return ok |
| Method: | int Drop( ) |
| Input: | None |
| Output: | Int Status |
| Description: | Drops Frame |
| Pseudocode: | Call the decaps to get data for next video frame. |
| | If last frame, set frame to nothing and return ok |
| | If decaps error, set error and frame to nothing, return error. |
| | Call the codec to drop the frame. |
| | If error, set error, and return error |
| | Return ok |
| Method: | void HandleError ( ) |
| Input: | WindowTitle |
| Output: | void |
| Description: | Displays a message to the user on error |
| Pseudocode: | Call Stop. |
| | If error was a decpas error, refer to decaps error handler and return |
| | If error was a codec error, refer to codec error handler and return |
| | Print The Error String |
| | Report Error to the user |

Class Name:

VideoRenderer

Description:

VideoRenderer handles all the video drawing capabilities of the egenie player.

Attributes:

Linked List of Video Modes. First item pointer
FirstEnumeratedMode
Current pointer for callback function use.
CurrentEnumeratedMode
DirectDraw object
g_pDD
DirectDraw primary surface
g_PDDSDisplay1
DirectDraw secondary surface
g_pDDSDisplay2
DirectDraw overlay surface (front buffer)
g_pDDSOverlay1
DirectDraw overlay surface (back buffer)
g_pDDSOverlay2
DirectDraw frame surface
g_pDDSFrame
DirectDraw Clipper Object
g_pClipper
Was a user specified size put into the player?
DefaultDisplay
Bit depth of decore surface,
DecoreBitsPerPixel
Bit depth of screen surface.
ScreenBitsPerPixel
decoding format that the decore will use.
VideoDecodeFormat
Pixel Code for Decore.
FourCCPixelFormat
Storage of Window Identifier
hWnd
Size of fullscreen display
W_screen_size_x
W_screen_size_y
The memory size of edge of the screen in bytes that doesn't get drawn to
W_Xoffset
W_Yoffset
X stretching information
W_XFrameScaleData
W_YFrameScaleData
This is the Full_Screen version of the display parameters
FS_screen_size_x
FS_screen_size_y
FS_Xoffeet
FS_Yoffset
FS_XFrameScaleData
FS_YFrameScaleData
This variable remembers if the video tenderer was previously initialised
MediaChanging
These variables are used on a warm.
Old_FS_SSX
Old_FS_SSY
Old_W_SSX
Old_W_SSY
Old_UsingOverlays
Old_SoftwareStretching
More accelerated video variables
g_bSoftwareStretching
SurfaceFrameCriteria
ForceSourceColourKeyOff
Total video memory available for using
AvailableVideoMemory
PrimaryDisplayVideoMemory
This is a memory of the supported rendering modes
AvailableRenderModes
Render tags
NoOverlayFlipping
UsingOverlays
total time taken to lock a frame
AverageLockTime
Counter for back buffer erasing (manually)
FirstFrames
Saves the window size & pos.
g_reWindow
g_reViewport
g_reScreen
Is the app in windowed or full screen mode.
g_bWindowed
App can't switch between full screen and window mode
g_bSwitchWindowFS
Error Handling
ErrorCode
ErrorMessage
Bitmap information from Decaps class
bih

Methods:

| Method: | VideoRenderer( ) |
|---|---|
| Input: | None |
| Output: | None |
| Description: | Constructor for VideoRenderer class |
| Pseudocode: | Initialise Media_Changing |
| | Initialise g_pDD |
| | Initialise ErrorMessage |
| | Initialise FirstEnumeratedMode |
| | Initialise ErrorCode |
| | Initialise g_bWindowed |
| | Initialise g_pDDSDisplay1 |
| | Initialise g_pDDSDisplay2 |
| | Initialise Old_FS_SSX |
| | Initialise Old_FS_SSY |
| | Initialise Old_W_SSX |
| | Initialise Old_W_SSY |
| | Initialise Old_UsingOverlays |
| | Initialise FirstFrames |
| | Initialise Old SoftwareStretching |
| Method: | Constructor(int ScreenSize_x,int ScreenSize_y,int |
| | FullScreen,BITMAPINFOHEADER * ThisBitMap) |
| Input: | See above |
| Output: | None |
| Description: | Constructor for VideoRenderer class after DirectX init |
| Pseudocode: | Initialise g_pDDSOverlay1 |
| | Initialise g_pDDSOverlay2 |
| | Initialise g_pDDSFrame |
| | Initialise g_pClipper |
| | Initialise ForceSourceColourKeyOff |
| | Initialise ForceDestinationColourKeyOff |
| | Initialise W_XFrameScaleData |
| | Initialise W_YFrameScaleData |
| | Initialise FS_XFrameScaleData |
| | Initialise FS_YFrameScaleData |
| | Initialise VideoDecodeFormat |
| | Initialise UsingOverlays |
| | Initialise DefaultDisplay |
| | Initialise FirstFrames |
| | Initialise SurfaceFrameCriteria |
| | Initialise ScreenBitsPerPixel |
| | Initialise DecoreBitsPerPixel |
| | Initialise g_bSwitchWindowFS |
| | Initialise bih |
| | If no screensize was specified, then |

If data !=1024 use the bih sizes for both window and full screen.
Else set a suze of 512×384 and this is for “no clip” mode.

Else if

Set the screen size to requested size.

| | End if |
|---|---|
| | Set to window mode is not fullscreen and not MediaChanging. |
| Method: | ˜VideoRenderer( ) |
| Input: | None |
| Output: | None |
| Description: | The default destructor |
| Pseudocode: | Delete variables by calling safe exit |
| Method: | void SafeExit(Destruct) |
| Input: | Variable to determine if interface should be destroyed |
| Output: | None |
| Description: | This function safely deletes all the dynamically allocated variables. |
| Pseudocode: | Destroy the Display structures, if they exist |
| | Destroys the handle to the Direct Draw object |
| | If Destruction of interface is required |

Free chain of linked list modes.

Safely delete W_XframeScaleData, W_YframeScaleData,

FS_XframeScaleData and FS_YFrameScaleData

| Method: | void HandleError(char * WindowTitle) { |
|---|---|
| Input: | char * |
| Ouput: | None |
| Description: | The error handler for the windows functions. |
| | Display a message to the user and return. |
| Pseudocode: | Call safeexit( ) |
| | Tell the user about the fault |
| Method: | void Close(void) { |
| Input: | char * |
| Ouput: | None |
| Description: | The error handler for the windows functions. |
| | Display a message to the user and return. |
| Pseudocode: | Call safeexit(don't destroy interface) |
| | Set MediaChanging to True |
| | Record current windows sizes (window and Fullscreen) |
| | Remember rendering mode. (Overlay and software) |
| | return |
| Method: | int ReleaseAllSurfaces( ) |
| Input: | None |
| Output: | Int |
| Description: | Release all surfaces used. |
| | Also when switching from windowed to full screen, all surfaces |
| | must be released. |
| Pseudocode: | Destroy the Display structures, if they exist, Primary Display, Overlays, frame. |
| Method: | Int CheckAvailableDisplayMode(int * SSX,int * SSY,int * |
| | BPP,int * RR) |
| Input: | int *, int*, int *,int * |
| Output: | Int |
| Description: | Checks if a display mode is available with the passed in criteria. |
| | Returns number if ok, −1 if error. |
| Pseudocode: | Start at start of linked list. |
| | Pass through linkedlist, comparing parameters of each mode to the requested |
| | one. |
| | If an acceptable mode is located, return the number. |
| | Else return −1 |
| Method: | BOOL VideoRenderer::RestoreAll(void) |
| Input: | None |
| Output: | None |
| Description: | Restore all lost objects |
| Pseudocode: | Call restore on each object if that object exists. |
| | Collectively grab the return result, and if all come back with OK then the return |
| | result is ok. |
| | Return result |
| Method: | int VideoRenderer::UpdateFrame(HWND hWnd) { |
| Input: | HWND |
| Output: | int |
| Description: | Take the bitmap data and send it to the videocard. |
| Pseudocode: | Create a directX surface description structure and initialise. |
| | If a pre-existing error is present return error |
| | If Rendering is software mode |

Lock the secondard Display for writing.
If error, store error and return error.
Calculate and store Xpitch.
If the FirstFrames is less than three.

Calculate the Y_Offset for displaying to the screen
Increment FirstFrames
Blank the entire memory area.

End if
Depending on 16,24 or 32 bit screen mode, run different

assembly language stretching code.

Set up initial variables for assembly language to pass from code.

Source data pointer
Destination data pointer
Width of Frame
Bytes per scan line
X Scaling Data
Y Scaling Data

Assembly Code
Loop each Vertical scan line

:: Y_All Loop
Grab Y repeat rows.
:: Y_Loop
Increment Y source line only if finished.
:: X Loop
Read pixel of data
Read number of time to be repeated.
Write that number of times.
Increment X
End of Row? No Jump to :: X Loop
Enough Y line repeated? No Jump to Y_Loop,
End of Rows? No Jump to Y_All Loop

Assemebly Code End
Unlock Display2 Surface.
If Error save error and return Error
While loop

If windowed Attempt to Bit Display2 to Display1
Else attempt to flip the displays.
If successful, return ok
If more than 200 attempts, give up, return error.
If surface lost, restore surfaces and continue
If surface busy, sleep and continue while loop
If other error, record error and return error

End While

Else If

If not usingoverlays then

Lock the frame surface
If error record error and return error
Memcopy the bitmap data to the frame memory
Unlock the frame surface
If error record error and return error
Get the desktop coordinates and calculate the screen
location for the data. Allow for letterboxing and
non 4×3 aspect ratio.
If FirstFrames is less than 3, blank Display2, prior to
flipping, increment firstframes
blt Display2 to Display1
If error record error and return error
While loop

If windowed Attempt to Blt Display2 to Display1
Else attempt to flip the displays.
If successful, return ok
If more than 200 attempts, give up, return error.
If surface lost, restore surfaces and continue
If surface busy, sleep and continue while loop
IF other error, record error and return error

End While

Else if

Lock the overlay surface
If error record error and return error
Memcopy the bitmap data to the overlay memory
Unlock the overlay surface
If error record error and return error
If FirstFrames is less man 3, blank Display1, prior to
displaying the overlay on the surface, increment
first frames
If Overlay flipping required

While loop

attempt to flip the overlays.
If successful, return ok
If more than 200 attempts, give up,
return error.
If surface lost, restore surfaces and
continue
If surface busy, sleep and continue
while loop
If other error, record error and return

error

End While

Else if

Call DisplayOverlay to perform update.

End if

End if

| | End If |
|---|---|
| | Return ok |
| Method: | HRESULT WINAPI EnumAllModesCallback( |
| | LPDDSURFACEDESC pddsd, LPVOID pVideoR ) |
| Input: | LPDDSURFACEDES, LPVOID |
| Output: | HRESULT WINAPI |
| Description: | For each mode enumerated, it adds it to the “All Modes” listbox. |
| Pseudocode: | Allocate memory for the display mode |
| | Copy the memory structure to the enumerated link list |
| | Check if first mode to be added to the linked list |
| | If first mode, then set up the pointers |
| | If not first mode, create and parse the linked list |
| Method: | int VideoRenderer::InitSurfaces(WindowSettingsMode |
| | WindowMemory) |
| Input: | int |
| Output: | int |
| Description: | Create all the needed DDraw surfaces and set the cooperative level |
| | with the operating system. |
| Pseudocode: | If windowed mode then |

If not MediaChanging

Set FirstFrames to zero
Set normal cooperative level with Direct X
If Error save error and return Error

End if
Set DestroyPrimaryDisplay to false
If Media changing then

If dimensions or resolution or render mode of primary display
If DestroyPrimaryDisplay is true then

Safely Release Display1
Safely Release Display2
SetWindowPosition back to orignal window.
Reset FirstFrames

End If

End if
Grab location of window relative to desktop.
If Display1 does not exist

Depending on render flags, create Display1
If Error save error and return Error

End if
Create Clipper
If Error save error and return Error
Set Clipper To Window
If Error save error and return Error
Set Clipper to display1
If Error save error and return Error
If not using overlays then

Create Display2
If Error save error and return Error

End if
If not using overlays and not software rendering.

Create frame surface
If Error save error and return Error

Else if

Set Frame surface equal to nothing.

End If

Else if

If should remember window settings

If not media changing

Grab location of window relative to desktop.

Else if

Create location for window on desktop.

End if

End if
If Media changing then
If dimensions or resolution or render mode of primary display

If DestroyPrimaryDisplay is true then

Safely Release Display1
Safely Release Display2
Reset FirstFrames

End If

End if
If Display1 does not exist

Depending on render flags, create Display1
If Error save error and return Error
If not using overlays

Create Display 2
If Error save error and return Error

Else if

Set Display 2 to nothing.

End if

End if
If not using overlays and not software rendering.

Create frame surface
If Error save error and return Error
Call PerformBlittingPerformanceTest
If fail return error

Else if

Set Frame surface equal to nothing.

End If

End if
If UsingOverlays

Create overlay surface
If Error save error and return Error
If flipping surface exists, grab it.
If Error save error and return Error

| | End If |
|---|---|
| Method: | int VideoRenderer::InitVideo( HWND *phWnd, |
| | TestingDisplayModes) { |
| Input: | HWND *, bool TestingDisplayModes |
| Output: | Int |
| Description: | Do work required for every instance of the application. Create the |
| | window, initialise data |
| Pseudocode: | If not media changing |

Create Interface to DirectX
If Error save error and return Error
Enumerate and store all supported modes along with supported bit
If Error save error and return Error
Call getAccurateVideoMemory
If Error save error and return Error

End if
GetCurrentDisplayMode
If Error save error and return Error
If not media changing

Call GetSupportedRenderMode
If Error save error and return Error

End if
Set original criteria for display selection
If DefaultDIsplay set requested size to current screen size.
If (Blitting Render Mode Available)

If desktop is 16bit and overlay mode is available goto OverlayMode
If desktop is 16,24 or 32 bit then

Set DecoreBPP to DesktopBPP
if enough video memory is available for some blitting

if AvailableDisplayMode

if Enough video memory available for full blitting

Set ScreenBPP equal DecoreBPP
Goto Blitting

End if
while DefaultDisplay and greater than 640 wide

if GetNextSmallestDisplaySize fails

Reset Variables
Goto OverlayingMode

end if
if available video Memory then

Set ScreenBPP = DecoreBPP
Goto Blitting

end if

End while
Reset variables
Goto OverlayingMode

End if
if not window mode

set error and return error

else if

Set ScreenBPP equal DecoreBPP
Set no Full screen switching.
Goto Blitting

end if

end if

End if

End if
Goto OverlayingMode
Blitting:
If not TestingDisplayModes is true

Call Initsurfaces
If error then reset variables and goto OverlayingMode

End if
Goto RenderModeSelected
OverlayingMode:
If OverlayRenderMode Available then

Test if any overlay Modes have stretching capabilities.
If not then goto SoftwareMode
Check if first located overlay has flipping surfaces available
If not, set no flipping flag.
If CheckAvailableVideoMemory returns ok then

OverlayFullScreenTest:

ScreenBPP = VideoModeBPP
if FS DisplayMode is Available then

If CheckVideoMemoryAvailable returns ok

Set usingOverlays to One
Goto Overlaying

End If
If Screen BPP > 16 then

Attempt reducing ScreenBPP to 16
If Memory Check is ok

Set usingOverlays to One
Goto Overlaying

Else If

Restore BPP.

End if

End if
while DefaultDisplay and X_size > 640

If Can't find small display Mode then

Reset Sizes
Break

End if
if Check Available Video Mode is ok

Set usingOverlays to One
Goto Overlaying

End if

End while
Set No overlay flipping to true
if Check Available Video Mode is ok

Set usingOverlays to One
Goto Overlaying

End if
Reset Variables
Goto SoftwareMode

EndIf
If Window Mode isn't selected

If DefaultDisplay is true

Report Message to User Direct X is not properly

Installed

Reset Variables
Permit FS switching
Goto SoftwareMode

End If
Set Error, return error

Else if

Set UsingOverlays to one
Remove FS switching
Goto Overlaying

EndIf

Endif
Set NoflippingFlagToTrue
If CheckAvailableVideoMemory returns no then

Reset Flipping Overlay Selected
If WindowModeRequired

Reset Parameters
Goto SoftwareMode

End If
Disable FullScreenSwitching

Endif
Goto OverlayFullScreenTest

Endif
Overlaying:
If not TestingDisplayModes is true

Call Initsurfaces
If error then reset variables and goto SoftwareMode

Endif
Goto RenderModeSelected
SoftwareMode:

Set Requested Display Mode (640×480)
Set DecoreBPP to ScreenBPP
If DecoreBPP is less than 16 then

Store error and return error

End if
Set ScreenBPP to DecoreBpp
Set SoftwreMode to true
If not TestingDisplayModes then

Call Initsurfaces
If error then reset variables and return

Endif
If not TestingDisplayModes then

Determine from aspect ratio of screen and video, blank

areas around the screen. Store in Offset Variables.

Create scaling data for full Screen and window mode for

Software stretching of the image. Store in Scale data
Variables.

End if
Set MediaChanging to false

| | Return ok |
|---|---|
| Method: | int ScreenSizeX(void) |
| Input: | None |
| Output: | Int |
| Description: | Return the screen size X |
| Pseudocode: | return FS screen size x or windowed depending on Windowed Mode |
| Method: | int ScreenSizeY(void) |
| Input: | None |
| Output: | Int |
| Description: | Return the screen size X |
| Pseudocode: | return FS screen size y or windowed depending on Windowed Mode |
| Method: | int BitsPerPixelMode (void) |
| Input: | None |
| Output: | VideoDecodeFormatType |
| Description: | Return the Bits per pixel mode |
| Pseudocode: | If Using Overlays |

Return VideoDecodeFormat

Else If

Return Bits per pixel of screen- (RGB565,RGB24,RGB32)

| | End IF |
|---|---|
| Method: | int BitsPerPixel (void) |
| Input: | None |
| Output: | Int |
| Description: | Return the bits per pixel used by the decore. |
| pseudocode: | Return DecoreBitsPerPixel |
| Method: | int GetCapsSafe(VideoCaps Pointer (×2)) |
| Input: | VideoCaps Pointer (×2) |
| Output: | Int |
| Description: | Provided the Direct X function call GetCaps “Safely” |
| Pseudocode: | If Software mode pointer is not NULL then |

Allocate memory for VideoCaps Structure
If error store error and return error
Clear memory

End if
If Video mode pointer is not NULL then

Allocate memory for VideoCaps Structure
If error store error and return error
Clear memory

End if
If Software mode pointer is not NULL then

Get Video Caps function.
If failed, resize structure
Get Video Caps function.
If failed, store error and return error

End if
If Video mode pointer is not NULL then

Get Video Caps function.
If failed, resize structure
Get Video Caps function.
If failed, store error and return error

| | End if |
|---|---|
| | Return ok |
| Method: | int GetSupportedRenderMode (void) |
| Input: | None |
| Output: | Int |
| Description: | Get the available render modes in the video card. |
| Pseudocode: | Call GetCapsSafe, if error return error. |
| | Set AvailableRenderModes to Software only. |
| | Check the caps structure for Video Memory Bltting and Blt stretching, |

if available, set Video Memory Blitting flag available.

Check the caps structure for System Memory Bltting and Blt stretching,

if available, set System Memory Blitting flag available.

Check the caps structure for destination colour key

if available, set Destination Colour Keying flag to available.

Check the caps structure for overlay capabilites
If available

If sufficient overlay surfaces are available

Create overlay surfaces (very small in size) and check
If they can be created with the 6 different colour modes,
record this fact. Attempt to create flipping overlays as
well. If available record this in available render mode.

End if

| | End if |
|---|---|
| Method: | int GetAccurateVideoMemory(void) |
| Input: | None |
| Output: | Int |
| Description: | Calculate the amount of video memory |
| Pseudocode: | Create surface description structure. |
| | Set Bits Per Pixel to current video display mode. |
| | Set size to 512 × 256. |
| | Create as many surfaces as possible, until no memory error message is |

received.

Halve the surface size
Create as many surfaces as possible, until no memory error message is

received.

Halve the surface size
Create as many surfaces as possible, until no memory error message is

received.

| | Determine the amount of memory allocated for the primary display. |
|---|---|
| | Sum all the surfaces memories together. |
| | Free all the surface memories. |
| Method: | int CheckAvailableVideoMemory (DWORD TypeOfSurface) |
| Input: | Type of surfaces required. |
| Output: | Int |
| Description: | Calculate the amount of video memory required for surfaces |
| Pseudocode: | Use existing setting in program to determine sizes and bits per pixel. |
| | Depending on the input parameters, check if each particular surface is |
| | Required. Add memory to sum total if that surface was required. |
| | If RequiredMemory is less than AvailableMemory return 0 |
| | Else return 1 |
| Method: | int GetNextSmallestFSDisplayMode (int BPP) |
| Input: | Int BPP |
| Output: | Int |
| Description: | Find the next smallest display mode with the same BPP. |
| Pseudocode: | Parse the linked list of display modes searching for the next smallest display |
| | mode. Find the one that is closest to the existing display mode, but only the next |
| | step smaller. |
| Method: | int PerformBlittingSpeedTest (int BPP) |
| Input: | None |
| Output: | Int |
| Description: | Performance test full screen blitting. |
| Pseudocode: | Create full screen surfaces. |
| | Attempt to flip them 5 times. |
| | (Must be done with cooperative level appropriately set) |
| | record the time it takes to write the data and flip the screens |
| | If any |
| | If longer then 100 milliseconds |
| | Fail the performance test and return 1 |
| | Else return 0 |
| Method: | int GetSliderBarCoords (RECT * Rectangle) |
| Input: | RECT * Rectangle |
| Output: | int |
| Description: | Return the coordinates of the slider bar in screen cords. |
| Pseudocode: | Using the predefined sizes, and querying windowsMetrix functions, populate a |
| | Rectangle with the dimensions of the slider bar, so it can be drawn |
| | appropriately. (Independent of Windows or full screen mode) |
| Method: | int GetSliderCoords (RECT * Rectangle,float ratio) |
| Input: | RECT * Rectangle, float ratio |
| Output: | RECT * Rectangle |
| Description: | Return the coordinates of the slider in Screen cords. |
| Pseudocode: | Using the predefined sizes, and querying windowsMetrix functions, populate a |
| | Rectangle with the dimensions of the slider on the slider bar, so it can be drawn |
| | appropriately. (Independent of Windows or full screen mode) |
| Method: | int DisplayOverlay (int ClearBackBuffer) |
| Input: | int ClearBackBuffer |
| Output: | Int |
| Description: | Display an overlay safely. |
| Pseudocode: | Create caps structure for video capabilities. |
| | Call GetCapsSafe. |
| | If error Store Error and return Error |
| | Determine alignment of the overlay, according to info provided by the caps |
| | structure. |
| | Determine stretching factor of overlay, |
| | According to DecoreBitsPerPixel, set colour key for screen. |
| | Setup the source rectangle from the dimensions of the image. |
| | Touch the alignment according to the Video Card capabilities. |
| | If Windowed mode |

Calculate the destination rectangle.
Offset from top of screen to user window.
Apply stretching factor, and use size of image.
Determine if the client window intersects the screen bounds.
If so clip the rectangle so the overlay only appears on the screen

That actually exists.

Else if

Else apply stretch scales, and use FS_offsets calculated in
Video_init function

End if
Touch the destination rectangle if the video capabilities indicate that it requires
to be moved.
If ClearBackBuffer

Create colour blitting structure.
Populate fill colour with black according to the video mode.
Colour Blt safe to the First overlay surface.
If the is overlay flipping then

Colour blit safe to the second surface

End If

End If
Set UnsupportedErrorOnce to false
While always

Attempt to Update the overlay
If ok delete allocated memory and return ok
If over 200 attempts, quit and store error and return error
If surface lost reported, then

restore all surfaces
if error return error

End if
If unsupported Error

If error has happened before return error
Else If

Set happened previously flag
Remove destination colour keying
continue

End If

End If
If generic Error

Attempt to remove Source colour keying and continue
Attempt to remove Destination colour keying and
continue
Else error if previous has been attempted.

End If
If no colour key hardware error

Attempt to remove Destination colour keying and
continue
Else error if previous has been attempted.

End If
Default - store error and return error

| | End While |
|---|---|
| Method: | int HideOverlay (void) |
| Input: | None |
| Output: | int |
| Description: | Remove the overlay from the viewing surface |
| Pseudocode: | If graphics device interface exists |

If overlays are in use

If Overlay 1 exists

Hide the overlay.
If error store and return the error.

End If

End If

| | End If |
|---|---|
| Method: | int LockSafe (Surface, surface description, ErrorCode) |
| Input: | As Above |
| Output: | int |
| Description: | Safely attempt to lock the video surface for drawing. |
| Pseudocode: | While always |

Attempt to lock the surface.
If attempts exceed 20, store error and return error
If result is ok return ok
If Surface lost, restore all surfaces and continue
If surface busy, sleep 5 ms and continue
If no Memory, store error and return error
Default - store error and return error

| | End While |
|---|---|
| Method: | int ColourBltSafe (Surface, surface description, ErrorCode) |
| Input: | AS above |
| Output: | int |
| Description: | Attempt to colour blit safely to the hardware. |
| Pseudocode: | Set timer. |
| | While always |

Attempt to colour blit using hardware
If attempt exceed 100, store error and return error.
If error generic or unsupported

Lock the working surface
If error, store and return
Get the clipper
If error, store and return
Get the clip list
If error, store and return
Parse the clip list, erasing the rectangles as necessary.
UnLock the working surface
If error, store and return

End If
If surface lost, restore surfaces and continue.
If surface busy, then wait 5ms and continue
Default - store error and continue.

| | End While |
|---|---|
| Method: | int ChangeCoopLevel (Window Handle, WhatToDo) |
| Input: | As Above |
| Output: | int |
| Description: | Switches display adapter between full screen and windows mode. |
| Pseudocode: | Call release all surfaces |
| | If error return error |
| | If not windowed |

Call restore Display Mode.
If error store error and return error
Set window position to something reasonable., or previous
If error store error and return error

Else If

Set window position to full screen
If error store error and return error

End If
Invert windowed flag
If reinitialisation is required,

Call InitSurfaces
If error store error and return error

| | End if |
|---|---|
| | Return ok |
| Method: | int DisplayVideoInformation( ) |
| Input: | WindowTitle |
| Output: | int |
| Description: | Provide a dialog box to the user displaying video information. |
| Pseudocode: | Populate string for displaying in dialog box, with information obtained about the |
| | video hardware. |
| | Particularily VideoMode used to render, date and version stamp, decore mode |
| | compatible with video card, bits per pixel of screen |
| | Create the message box and display. |
| Method: | int DisplayTextOnVideo (Message, DisplaySelectionBar) |
| Input: | As above |
| Output: | int |
| Description: | Display information bar on the video screen. |
| Pseudocode: | Use GDI to draw a bar on the screen |
| | If the drag and drop bar is required, draw that in as well. |
| | Use Slider Bar position functions and |
| | Slider position functions. To place the slider bar |

Class Name:

InputMedia

Attributes:

Status variables
mode
filename
ReSeekInputThread
Operating system Interface variables
file
Decoupling buffer variables
buffer
RamBuffer
RamBufferMutex
FileIOHandle
FileIOMutex
BufferStartedMode
Data Status variables
file_size
InitialFill
IOFilePointer
ReqFilePointer
EOFInputFile
AVI_DataReadingMode
AVI_file_size
lastReadPos
Computer status variables
InputMediaReadRate
Error handling variables
ErrorMessage
ErrorCode
Thread handling variables
ThreadDead
WaitingThread

Methods:

| | |
|---|---|
| Method: | InputMedia( ) |
| Input: | None |
| Output: | None |
| Description: | InputMedia constructor. Initialises all the variables |
| | used by the |
| | InputMedia class |
| Pseudocode: | this−>file = NULL |
| | this−>mode = −1 |
| | ErrorMessage = NULL |
| | ErrorCode = 0 |
| | FileIOMutex = NULL |
| | RamBufferMutex = NULL |
| | RamBuffer = NULL |
| | FileIOHandle = NULL |
| | ThreadDead = 0 |
| | WaitingThread = 0 |
| | BufferStartedMode = false |
| | AVI_DataReadingMode = false |
| | StartOfAVIData = 0 |
| | ReqFilePointer = 0 |
| | IOFilePointer = 0 |
| | EOFInputFile = false |
| | ReSeekInputThread = false |

| | |
|---|---|
| Method: | KillInputThread ( ) |
| Input: | None |
| Output: | Integer |
| Description: | Kills the reading thread and tidies up.. |
| Pseudocode: | BufferStartedMode = false |

If(Thread exists)

Set thread waiting to exit flag to one.
Set counter to zero.
While (counter < 10)

Sleep(10ms)
Increment counter
If(counter = = 10) then

Terminate thread
Return

End if

End while
FileIOHandle = nothing
End if

return

| Method: | ˜InputMedia( ) |
|---|---|
| Input: | None |
| Output: | None |
| Description: | InputMedia destructor. Cleans up all memory allocated to |
| | InputMedia. |
| Pseudocode: | KillInputThread( ) |
| | If file is open Close the file |
| | If FileIOMutex Exists Safely Destroy Mutex |
| | If RamBufferMutex Exists Safely Destroy Mutex |
| | If RamBuffer Exists Safely Destroy Buffer. |
| Method: | StartBuffer(StartOffset) |
| Input: | Offsets into file to commence buffering |
| Output: | Successful completion |
| Description: | Start Buffer - Starts reading the file from disk and pre- |
| | charges the |
| | buffer. |
| Pseudocode: | Rewind the file. |
| | Calculate offset for buffering into the file. |
| | Create the reading thread |
| | Set BufferstartedMode to true |
| | Set Initial fill to true |
| | Wait while thread fills the RAM Buffer. |
| | Calculate time required to fill the input buffer, store in |
| | InputMediaReadRate. |
| | Set InitialFill to false |
| | Set up Buffered Offset, store in ReqFilePointer. |
| | Always return Zero |
| Method: | int Open(char *IpFilename, int mode, int type) |
| Input: | char *IpFilename, int mode, int type |
| Output: | Int |
| Description: | Opens file IpFilename depending on mode and type |
| Pseudocode: | If IpFilename exists then |

initialize file
switch depending on type

case INPUT_TYPE_FILE:

switch depending on mode

case INPUT_OPEN_BINARY:

open IpFilename
break

case INPUT_OPEN_ASCII:

open IpFilename
break

default:

open IpFilename

end switch
if file does not exist

return 0

end if
mode = INPUT_TYPE_FILE
filename = IpFilename
set Windows read buffer to 32k
seek the end of the file
get the size of the file
seek from start of file
Allocate memory for the RAM Buffer.
Create RAMBUFFERMutex
If Create failed return 0
Create FileIOMutex
If Create failed return 0
return 1
break

default:

break

end switch

| | end if |
|---|---|
| | return 0 |
| Method: | DWORD WINAPI FileReadThread( ) |
| Input: | LPVOID TinputMedia |
| Output: | DWORD WINAPI |
| Description: | Reads the input file from disk into a RAM Buffer. |
| Pseudocode: | Store the pointer for the Input media class and type cast. |
| | Create a 32k read buffer. |
| | If Create failed set WaitingThread to 1 |
| | Seek to start of Data in file. |
| | While (!WaitingThread) |

Set Data Quantity to 32k
Check if the data read from the buffer is greater
than half way
through the buffer and End Of File hasn't been
reached
and BufferSttartedMode is true.

Grab FileIOMitex wait for ever
Read DataQuantity from file into ReadBuffer
Check if 32k was read if not

If fstream reports EOF then

Set EndOfFile Flag to True

Else Error as file can't be read.
End if

Release FileIOMutex
Grab RamBufferMutex wait for ever.
Copy ReadBuffer to RAMBuffer
Update Read Pointer
Release RamBufferMutex
If not InitialFill Sleep for 20 milliseconds

Else if

Sleep 50 milliseconds

End if

End while
Delete readBuffer
Set WaitingThread to zero
Set ThreadDead to 1
Exitthread
Return 0

| | |
|---|---|
| Method: | int isOK( ) |
| Input: | None |
| Output: | Int |
| Description: | Returns true if file exists |
| Pseudocode: | return this−>file if not equal to NULL |

| | |
|---|---|
| Method: | getFilename( ) |
| Input: | None |
| Output: | char * |
| Description: | Returns file name |
| Pseudocode: | return this−>filename |
| | return NULL |

| | |
|---|---|
| Method: | getSize( ) |
| Input: | None |
| Output: | DWORD |
| Description: | Returns file size |
| Pseudocode: | If this−>file = 1 |

return this−>file_size

end if
return 0

| Method: | int Read(char *data, unsigned int size) |
|---|---|
| input: | Ram Buffer for Data extraction, Size - amount of data. |
| Output: | Int |
| Description: | Read data of specified size |
| Pseudocode: | If The thread Has exited and BufferStartedMode then |
| | assume fault and return 0 |
| | Switch depending on mode |

case INPUT_TYPE_FILE: (currently only one)

if the file isn't open and the RamBuffer exists
then return

0

if(ReSeekInputThread) then

if(KillInputThread( )) returns a fault return
0
Calculate position in file to seek to.
StartBuffer(calculated position)
Reset file pointer
Set ReSeekInputThread to false

end if
if (DataRequested is contained in the RAM
Buffer) then

if the thread has died return false.
Grab RamBuferMutex wait indefinitely
Copy the memory from the buffer
Release the RamBufferMutex
Update ReqFilePointer
Return Size

else if

Grab FileIOMutex Wait indefinitely
Grab the current file position.
Seek to the requested read location
Read data from file.
Seek to the old location in the file.
Release FileIOMutex
Return Number of Bytes writen

end if
break

default:

| | end switch |
|---|---|
| | return 0 |
| Method: | int Seek(int size, unsigned int method) |
| Input: | Long Seek, reference starting point |
| Output: | Int |
| Description: | Seeks in the file depending on method |
| Pseudocode: | Switch depending on mode |

case INPUT_TYPE_FILE:

if the file exists

Check if EOF is set, if so unset it
prior to seeking.
switch depending on method
case INPUT_SEEK_SET:

seek in file
break

case INPUT_SEEK_CUR:

if size equals 0

return current file position

else

Jump to new location
Return 0

end if
break

case INPUT_SEEK_END:

Set file pointer to End-- seek
return 0
break

end switch

end if
break

default:

end switch
return 0

| | |
|---|---|
| Method: | int Close( ) |
| Input: | None |
| Output: | Int |
| Description: | Closes all uneeded methods |
| Pseudocode: | If the file exists |

close file

end if
If it exists, safely delete the RAMBuffer
return 1

| | |
|---|---|
| Method: | int ThreadHealthy( ) |
| Input: | None |
| Output: | Int |
| Description: | Reports if thread is healthy |
| Pseudocode: | return ThreadDead |

| | |
|---|---|
| Method: | int HandleError( ) |
| Input: | Char * WindowTitle |
| Output: | None |
| Description: | Writes an error description for the user to interpret |
| Pseudocode: | Close the media file |
| | Write the Error Message / Error Code to a preformatted |
| | String. |
| | If the error code is not 4070 (CDROM eject), then Display |
| | Message in a dialog |
| | box. |
| | return |

Class Name;

AviDecaps

Description:

AviDecaps sets up the file by reading in all information needed for playback

Attributes:

details of the video frames
bitmapinfoheader
details of the video audio
waveformatex
MPwaveformatex
Video characteristics variables
width
height
fps
Video Compressor details
compressor
video_strn
video_frames
video_tag
video_pos
Audio Characteristic Variables
a_fmt
a_chans
a_rate
a_bits
audio_strn
audio_bytes
audio_chunks
audio_tag
audio_posc
audio_posb
AVI handling variables
pos
n_idx
max_idx
idx
video_index
audio_index
last_pos
last_len
must_use_index
movi_start
Input Media handling variables
hIOMutex
input
Error handling variables
ErrorCode
ErrorMessage
Track counting variables
CurrentlyPlayingTrack

| Method: | AviDecaps( ) |
|---|---|
| Input: | None |
| Output: | None |
| Description: | AviDecaps constructor. Initializes all the variables used |
| | by the |
| | class |
| Pseudocode: | video_pos = 0 |
| | audio_posc = 0 |
| | audio_posb = 0 |
| | idx = NULL |
| | video_index = NULL |
| | audio_index = NULL |
| | input = NULL |

ErrorMessage = NULL
ErrorCode = 0
this−>hIOMutex = NULL
this−>CurrentlyPlayingTrack = 0

| | |
|---|---|
| Method: | ˜AviDecaps( ) |
| Input: | None |
| Output: | None |
| Description: | AviDecaps destructor. Cleans up all memory allocated to |
| | AviDecaps |
| Pseudocode: | Close all open files and delete temporary data structures |

| | |
|---|---|
| Method: | int IsAVI( ) |
| Input: | None |
| Output: | Int |
| Description: | Returns true if its an avi |
| Pseudocode: | If input exists |

If a chunk of data was read incorrectly

Error “Error Reading”
return 0

end if
if the chunk of data is not identified as been an
AVI

return 0

end if
return 1

end if
return 0

| | |
|---|---|
| Method: | int SampleSize( ) |
| Input: | None |
| Output: | Int |
| Description: | Returns the sample size of the first audio stream |
| Pseudocode: | Work out sample size |
| | return size |

| Method: | int FillHeader(int getIndex) |
|---|---|
| Input: | Int |
| Output: | Int |
| Description: | Fill the class with info from headers and reconstruct an |
| | index if |
| | wanted. |
| Pseudocode: | read through the AVI header file (according to AVI RFC) |
| | extract the header objects |
| | verify the AVI header objects. |
| | read start position of the ‘movi’ list and optional idx \| |
| | tag |
| | interpret the index list |
| | generate the video index and audio index arrays. |
| Method: | int AddIndexEntry(char *tag, long flags, long pos, long |
| | len) |
| Input: | char *tag, long flags, long pos, long len |
| Output: | Int |
| Description: | Add an entry to the global index this function is used |
| | while |
| | reading. |
| Pseudocode: | If n_idx is greater or equal to max_idx |

Reallocate: memory for idx
max_idx equals max_idx plus 4096
idx = (char((*)[l6])) ptr

| | end if |
|---|---|
| | add the index entry |
| | Update counter |
| | Increment n_idx |
| | return 0 |
| Method: | BOOL isKeyframe(long frame) |
| Input: | long frame |
| Output: | BOOL |
| Description: | Returns true if key frame |
| Pseudocode: | If frame number is less than 0 |

Set frame = 0

end if
if there is no video index

return 1 to avoid looping on waiting for a keyframe

| | end if | |
|---|---|---|
| | return key frame flag | |
| Method: | Int Open(char *IpFilename, int type) | |
| Input: | char *IpFilename, int type | |
| Output: | Int | |
| Description: | Tries to open an AVI with and without an index | |
| Pseudocode: | If IpFilename exists | |
| | | create new InputMedia Class for data |
| | | reading |
| | else | Return appropriate error code. |

end if
if file was not opened correctly

delete input
return 0

end if
initialize video_pos
initialize audio_posc
initialize audio_posb
initialize idx
initialize video_index
initialize audio_index
if input is not ok

delete input
initialize input
return 0

end if
Read Encoded Header from Already Opened file
Check for reading Errors,

if error return 0,

Get Encryption parameters from executable file.
Verify file is authentic Egenie File..

If error return

Read Header from inside EGM file

If error return 0

Decrypt Header.
Verify Header

If error return

Extract File name details.
Extract Number of files.
Check if this is the first time reading this file.
If first time

Create Track index structure (Linked
List)

End if
Select Track for reading.
Verify the Track Number is valid.

If error return

Create memory structures for decrypting AVI file
Commence Decompression/Decryption of AVI
Record the length of the AVI file
Call InputMedia SetAviReadMode with Encryption Para-
meters and AVI

file details.

Tidy up temporary structures used for extraction.
Tidy up temporary structures used for deletion
if its an AVI

ifthis−>FillHeader(1)

return 1

else

seek input
IsAVI( )
If this−>FillHeader(0)

return 1

end if

end if

end if
return 0

| Method: | Int VideoStreams( ) |
|---|---|
| Input: | None |
| Output: | Int |
| Description: | Returns the total number of video streams |
| Pseudocode: | return video_strn |
| Method: | Int AudioStreams( ) |
| Input: | None |
| Output: | Int |
| Description: | Returns the total number of audio streams |
| Pseudocode: | return this−>audio_strn |

| Method: | int Width( ) |
|---|---|
| Input: | None |
| Output: | Int |
| Description: | Returns the video width |
| Pseudocode: | return width |
| Method: | Int Height( ) |
| Input: | None |
| Output: | Int |
| Description: | Returns the video height |
| Pseudocode: | return height |

| Method: | BITMAPINFOHEADER *BitmapInfoHeader( ) |
|---|---|
| Input: | None |
| Output: | BITMAPINFOHEADER * |
| Description: | Returns the bitmapinfoheader associated with the first |
| | video |
| | stream. |
| Pseudocode: | return bitmapinfoheader |
| Method: | Int FrameSize(unsigned long frame_number) |
| Input: | unsigned long frame_number |
| Output: | Int |
| Description: | Gives the size of a particular frame |
| Pseudocode: | If video_index docs not exist |

return −1

end if
if frame_number is smaller then 0
or frame_number is greater or equal to video_frames

return −1

end if
return frame length

| | |
|---|---|
| Method: | Double FrameRate( ) |
| Input: | None |
| Output: | Double |
| Description: | Return the framerate |
| Pseudocode: | If frames per second equals 0 |

frames per second is 25

end if
if frames per second equals 23

frames per second is 25

end if
return frames per second

| | |
|---|---|
| Method: | Long TotalFrames( ) |
| Input: | None |
| Output: | Long |
| Description: | Returns number of video frames |
| Pseudocode: | return thisvideo_frames |

| Method: | Int NextVideoFrame(char *buffer) |
|---|---|
| Input: | char *buffer |
| Output: | Int |
| Description: | Reads the next video Frame into buffer, return the actual |
| | size of |
| | the frame. |
| Pseudocode: | If video index exists |

return −1

end if
if video_pos is smaller then 0 or video_pos greater
or equal to video frames

return −2

| | end if |
|---|---|
| | Request the mutex for reading the file |
| | Release the Mutex |
| Method: | int AviDecaps::ReadAudio(char *audbuf, int bytes) |
| Input: | Long |
| Output: | Int |
| Description: | Seek to a particular video frame. |
| Pseudocode: | If audio index does not exist |

Error “No audio index”
return −1

end if
Request the read Mutex
loop until parsed enough chunks for the amount we want

release the read Mutex

end loop
return nr

| | |
|---|---|
| Method: | Int VideoSeek(long frame) |
| Input: | Long |
| Output: | Int |
| Description: | Seek to a particular video frame. |
| Pseudocode: | If video_index exists |

return −1

end if
if (frame is smaller than 0 ) frame equals 0

video_pos equals frame

end if
return 1

| | |
|---|---|
| Method: | Int AudioSeek(long bytes) |
| Input: | Long |
| Output: | Int |
| Description: | Seek to a particular audio. |
| Pseudocode: | If audio index does not exist |

return −1

end if
if bytes is less then 0

bytes equals 0

n0 equals 0
n1 equals this−>audio_chunks
while n0 is smaller then n1 − 1

work out position

end while
if audio length is greater than 1000

work out audio_posb

else

audio_posb equals 0

end if
return 0

| Method: | Int NextKeyFrame( ) |
|---|---|
| Input: | None |
| Output: | Int |
| Description: | Works out next key frame |
| Pseudocode: | increment video_pos |
| | while( not a key frame and haven't reached the end) |

increment video_pos

end while
return 1

| | |
|---|---|
| Method: | int PreviousKeyFrame( ) |
| Input: | None |
| Output: | Int |
| Description: | Works out previous key frame |
| Pseudocode: | Decrement video_pos by two |

(since we read the last frame)

while not key frame and haven't reached the beginning

decrement video_pos

end while
return 1

| | |
|---|---|
| Method: | Int Seek(int percent) |
| Input: | None |
| Output: | Int |
| Description: | |
| Pseudocode: | Compute the desired frame number |

Go to the next keyframe
Set video position
If there are more then one audio stream

Calculate what ratio it corresponds to
Set audio position
return 1

end if
return 1

| | |
|---|---|
| Method: | Int ReSeekAudio( ) |
| Input: | None |
| Output: | Int |
| Description: | Seeks Audio |
| Pseudocode: | If there are more man 0 AudioStreams |

WaitForSingleObject(this−>hIOMutex, INFINITE)
Calculate what ratio it corresponds to set audio
position

End if
Return 1

| Method: | WAVEFORMATEX *WaveFormatEx( ) |
|---|---|
| Input: | None |
| Output: | WAVEFORMATEX * |
| Description: | Returns the wavefromatex associated with the first |
| | audio stream |
| Pseudocode: | return &this−>waveformatex |
| Method: | Double GetProgress( ) |
| Input: | None |
| Output: | Double |
| Description: | Return progress |
| Pseudocode: | return (double) ((double)(this−>video pos))*100.0/ |
| | ((double)this−>video_frames) |

| | |
|---|---|
| Method: | int GetBufferingState( ) |
| Input: | None |
| Output: | Int |
| Description: | Returns buffer state |
| Pseudocode: | If input does not equal to NULL |

return buffer state

end if
return 0

| | |
|---|---|
| Method: | int Close( ) |
| Input: | None |
| Output: | Int |
| Description: | Closes and frees all memory allocations no longer required |
| Pseudocode: | If input exists |

Close input
delete input
initialize input to NULL

end if
if idx exists

free idx

end if
if video_index exists

free video_index

end if
if audio_index exists

free audio_index

end if

Class Name:

Playback

Description:

Attributes:

Windows interface variables.
g_hInstance
hWnd
Application state variables
g_bActive
g_bReady
State of playback variables
MediaChanging
FirstTimePlayed
playing
paused
fullscreen
PlayBackFailed
Requested volume
volume
NoSound
Synchronising variables
pausedticks
baseTime
stopTime
DisplayTimes[DISPLAY_SAMPLES]
Track changing variables
TrackChangingTimer
NextTrack
TrackChangePaused
CurrentlyPlayingTrack
ResetPositionFlag
Track selection variables
TrackIndex
TrackTitleIndex
SingleTrackOnly
User Interface variables
MouseDraggingSlider
CurrentSliderPosition
Summation statistics
video_frames
displayed_frames
audio_bytes
User requested screen size
WindowResolution_x
WindowResolution_y
Error function variables
WindowTitle
ErrorCode
ErrorMessage
Access to other class variables
videoRenderer
audioRenderer
decaps
codec
audioCodec
videoBuffer
CDROM eject detection variables
FileDriveLetter

Methods:

| Method: | Playback(Window, Size_x, Size_y, hInst, CMDLine, |
|---|---|
| | TheSingleTrackOnly, FirstTime) |
| Input: | As above |
| Output: | None |
| Description: | Default constructor. Initialises all base variables used in playback |
| | class |
| Pseudocode: | initialise WindowResolution = Size |
| | initialise MediaChanging |
| | initialise WindowTitle to “Egenie Player” |
| | initialise CurrentlyPlayingTrack |
| | initialise videoRenderer |
| | initialise fullscreen to not Window |
| | initialise WindowResolution_x to Size_x |
| | initialise WindowResolution_y to Size_y |
| | initialise PlayBackFailed |
| | initialise volume |
| | initialise SingleTrackOnly to TheSingleTrackOnly |
| | initialise FirstTimePlayed to FirstTime |
| | initialise MouseDraggingSlider |
| Method: | Constructor( ) |
| Input: | As above |
| Output: | None |
| Description: | Default constructor. Initialises all (per) instance variables used in |
| | Playback class |
| Pseudocode: | initialise g_bActive |
| | initialise g_bReady |
| | initialise WindowTitle |
| | initialise codec |
| | initialise decaps |
| | initialise audioCodec |
| | initialise audioRenderer |
| | initialise playing |
| | initialise paused |
| | initialise NoSound |
| | initialise TrackChangingTimer |
| | initialise TrackChangePause |
| | initialise TrackIndex |
| | initialise TrackTitleIndex |
| | initialise ErrorCode |
| | initialise ErrorMessage |
| | initialise DisplayTimes |
| Method: | Playback( ) |
| Input: | None |
| Output: | None |
| Description: | Delete and free all memory associated with Playback class |
| Pseudocode: | If the videoRenderer exists and not windowed, switch to windowed |

mode.

| | Hide the main window |
|---|---|
| | Safely delete the audiorenderer. |
| | Safely delete the videoRenderer. |
| | Safely delete the codec. |
| | Safely delete the decaps. |
| | Safely delete the audioCodec. |
| Method: | Int Close( ) |
| Input: | None |
| Output: | Int |
| Description: | Delete and free all memory associated with Playback class, |
| | that is not required for track changing. |
| Pseudocode: | Safely delete the audiorenderer, but first remember the volume setting. |
| | Safely close the videoRenderer. |
| | Safely delete the codec. |
| | Safely delete the decaps. |
| | Safely delete the audioCodec. |
| | Set MediaChanging to true |
| | Safely delete the Track index |
| | Safely delete the track title index. |
| | Return ok |
| Method: | void HandleError(char * WindowTitle) { } |
| Input: | char* |
| Output: | void |
| Description: | The error handler for the windows functions. Display a message to |
| | the user and return. |
| Pseudocode: | Set PlayBackFailed to true |
| | If error was a subcode, instantiate the required handler for the correct class. |
| | Make sure to remove fullscreen mode prior to attempting to display a message |
| | box. |
| | Tell the user about the fault. |
| Method: | int InitApplication(HINSTANCE hInstance, int nCmdShow) |
| Input: | HINSTANCE, int |
| Output: | int |
| Description: | Do work required for every instance of the application: |
| | Create the window, initialize data |
| Pseudocode: | Calculate the proper size for the window, |
| | given a client of Screen_size_X and Screen_size_y |
| | Check for windowed mode. |
| | If non windowed, don't worry about the TOPMOST setting |
| | Create a window for WINDOWED MODE |
| | Save the window handle for future use |
| | If the window handle was invalid, store error and return error. |
| | Return ok |
| Method: | int Open(IpFilename, type, hInstance, TrackToPlay, MedTit) |
| Input: | As above |
| Output: | int |
| Description: | Opens file IpFilename for playback, sets up all variables |
| Pseudocode: | Call constructor |
| | If a filename doesn't exists then |

Create a videorenderer.
If error store error, handle error and return.
Call video renderer constructor.
Call initapplication
If error store error, handle error and return.
Call bit the video renderer.
If error store error, handle error and return.
Call display Video Information
Return ok

End If
Create decaps structure with filename
If error store error, handle error and return.
Open decaps structure.
If error store error, handle error and return.
Store currently playing track
Store all track titles.
Get the drive letter where the media is being executed from.
Store for later Media ejection test
Create audioCodec structure with filename
If error store error, handle error and return.
Check AudioCodec
If error set no sound to true.
If not MediaChanging and the videoRenderer is non existant

Create videoRenderer structure

If error store error, handle error and return.

End If
Call Constructor for the videoRenderer
If not NoSound, create the audioRenderer
If error store error, handle error and return.
If not Media changing then initApplication
If sound then
Set up AudioRenderer.

If trivial error, set no sound to true and continue
Else store error, handle error and return

| | End if |
|---|---|
| | Initialise the videoRenderer |
| | If error store error, handle error and return. |
| | Create codec structure |
| | If error store error, handle error and return. |
| | Verify the codec is ok |
| | If error store error, handle error and return. |
| | Set playing and paused to false |
| | Create videoBuffer structure |
| | If error store error, handle error and return. |
| | Initialise the videoBuffer |
| | If error store error, handle error and return. |
| | Set Media changing to false |
| | Return ok |
| Method: | unsigned long VideoTime( ) |
| Input: | None |
| Output: | unsigned long |
| Description: | Return the current video time in ms |
| Pseudocode: | If decaps exists and frame rate does not equal to 0 |

return (unsigned long)
video_frames * 1000.0 / FrameRate

else

return 0

| | end if |
|---|---|
| Method: | Int GetTime( ) |
| Input: | None |
| Output: | Int |
| Description: | Gives Global Time |
| Pseudocode: | return VideoTime/1000 |
| Method: | Int GetTotalTime( ) |
| Input: | None |
| Output: | Int |
| Description: | Gives Global Time |
| Pseudocode: | If decaps structure exists |
| | return total frames / frame rate |
| Method: | int Width( ) |
| Input: | None |
| Output: | int |
| Description: | Returns the video width |
| Pseudocode: | If decaps exists |

return width of video

| | end if |
|---|---|
| Method: | Int Height( ) |
| Input: | None |
| Output: | int |
| Description: | Returns the video height |
| Pseudocode: | If decaps exists |

return height of video

else

return 0

| | end if |
|---|---|
| Method: | BOOL isPaused( ) |
| Input: | None |
| Output: | BOOL |
| Description: | Returns if playback is paused or not |
| Pseudocode: | return paused variable |
| Method: | int Play(IgnoreQuality) |
| Input: | Ignore quality message |
| Output: | int |
| Description: | Plays file |
| Pseudocode: | If already playing then return ok |
| | Set playing to true and paused to false |
| | Initialise video_frames |
| | Initialise displaycd_frames |
| | Initialise audio_bytes |
| | Start the Video Buffer |
| | Perform the timing calculations here to determine how good the presentation |
| | will be |
| | If quality is not not ignored |

Get information from AudioCodec, videoBuffer, InputMedia, decaps

and determine if it is marginally or worse slower.

If it is switch the videoRenderer to fullscreen and calculate the
time to render a frame.
Adjust the timing calculation with rendering time, and determine
quality of video playback.
Report quality message to user, if appropriate

| | End if |
|---|---|
| | IF sound is available, start the audiorenderer. |
| | If error, store error, handle error and return. |
| | Show the playback window |
| | Return ok |
| Method: | int Resume( ) |
| Input: | None |
| Output: | int |
| Description: | Unpauses playback |
| Pseudocode: | Hide the mouse cursor |
| | If seeking then |

If audio then reseek the audio
If error, store error, handle error and return.

End if
If audio

Resume the audio
If error, store error, handle error and return

| | End if |
|---|---|
| | Restart the Video |
| | Reset the synchronising of the video. |
| | Set flag to wipe back buffer. |
| Method: | int Pause( ) |
| Input: | None |
| Output: | Int |
| Description: | Pause the Playback Stream |
| Pseudocode: | Safely pause the audio Renderer |
| | Safely pause the videorenderer. |
| | Draw the drag and drop bar. |
| | Set Cursor to standard cursor. |
| | Set seek flag to not. |
| | Return ok |
| Method: | int ShowPlayBackWindow ( ) |
| Input: | Type to display |
| Output: | int |
| Description: | Updates the screen according to request. |
| Pseudocode: | Hide, show, or update overlays depending on the programs request |
| Method: | int PlayFrame(void) |
| Input: | None |
| Output: | int |
| Description: | Displays a frame, and performs the synchronising. |
| Pseudocode: | Get current time difference between audio and video. |
| | Estimate time required to display the next frame. |
| | Check if the audio is running ahead of the video. |
| | If audio is considerably ahead, drop frames to catch up. |
| | If audio is considerably behind, wait |
| | Else Start processing a frame |
| | Get frame from video buffer |
| | If error, store error, handle error and return. |
| | Increment frames played |
| | Check if it was the last frame, if so return Last_frame |
| | If not |

If paused return ok
Pass the frame to the video renderer
If error, store error, handle error and return.
Update synchronising variables

| | End if |
|---|---|
| | Return ok |
| Method: | int SwitchFullScreen ( ) |
| Input: | None |
| Output: | int |
| Description: | Switch the video Renderer between windowed mode and full |
| | screen.. |
| Pseudocode: | If video renderer is ok, |

Call change coop level on video renderer
If error, store error, handle error and return.

Else if

store error, handle error and return.

| | End if |
|---|---|
| | Return ok |
| Method: | int PaintLastFrame ( ) |
| Input: | None |
| Output: | int |
| Description: | Updates the screen with the last frame. |
| Pseudocode: | If video renderer is ok, |

Call update frame on video renderer with last frame
If error, store error, handle error and return.

Else if

store error, handle error and return.

| | End if |
|---|---|
| | Return ok |
| Method: | int AreThreadsHealthy ( ) |
| Input: | None |
| Output: | int |
| Description: | Tests if all threads are still processing.. |
| Pseudocode: | If playback failed return fault |
| | If audioRenderer thread is failed and sound is required return fault. |
| | If sound had stalled, set no sound is required, and continue. |
| | If Input reading thread is failed, return error |
| Method: | int DrawSelectionBar ( ) |
| Input: | None |
| Output: | int |
| Description: | Draws the slider bar on the screen. |
| Pseudocode: | Generates the text for the mouse slider bar, and displays it on the screen. |
| | Return ok |
| Method: | int InsideAllBounds ( ) |
| Input: | Input rectangle |
| Output: | Int |
| Description: | Verify if the mouse cursor is with the specified rectangle. |
| Pseudocode: | Return true if the above is true |
| Method: | int Seek 0 |
| Input: | Percentage |
| Output: | int |
| Description: | Reseeks the media. |
| Pseudocode: | Set cursor to waiting cursor. |
| | If first seek while paused, then kill input thread |
| | Seek the decaps |
| | Update the video position |
| | Start the video buffer |
| | Paint the last frame |
| | Redraw the selection bar |
| | Set cursor to normal cursor |
| | Return ok |
| Method: | int PlaybackWindowProc ( ) |
| Input: | Standard windows messaging functions. |
| Output: | int |
| Description: | Handles the windows messages for the window. |
| Pseudocode: | In case of particular message do, |

If Activate Message, then

Set app to inactive, or active depending on request

End If
If Command Message, then

If switch ALT-ENTER message

Pause the video.
Switch between window and fullscreen
Resume the video

End If

End If
If resize message

If fullscreen break
Else move window, do not resize.

End If
If close message

Set playback failed and return

End If
If destroy message

Set playback failed and return

End If
If left click down message

If not paused return
Get coordinates of slider and bar
If inside sliderBar

| | |
|---|---|
| v | If inside slider |

Set mouse dragging slider to true and return.

End If

Seek the playback
End If

End If
If mouse move message

If mouse is dragging slider, redraw slider in correct location.

End If
If left click up message

If mouse is dragging slider, seek video to new location.

End If
If key pressed message

If space bar

Pause or resume as necessary.

End if
If escape

Set playback failed and return.

End if
If up

If sound available increase volume.

End if
If down

If sound available decrease volume.

End if
If left

If appropriate, pause video and display start of track.
Else if subsequent press, display prior track.
Update screen accordingly

End if
If right

If appropriate, pause video and display next track.
Else if subsequent press, display next track.
Update screen accordingly

End if

End If
If re paint screen message

If paused, repaint the last frame and draw the selection bar.
Else, wipe the back buffer if appropriate.

End If
If device Change message

Check if our media has been removed. If so, fail playback

and exit accordingly

End if
If set cursor message

Clear cursor if paused.

End If
If move message

Move the window to new location.

End If
If system menu messages

Return and don't process

End if

End if
Return ok

Class Name:

SplashScreen

Description:

Displays the starting screen and the ending screen for the application.

Attributes:

End Screen Variables
NoListBox
SingleTrack
bSplashScreen
StartUpTicksCounter
Return Value
Replay
Windows Interface variables
hInst
OldCursor
URLFont
TheWindow
List Box contents
MedTit
Component Variables
OldCursorValid
Visited_Egenie
Visited_Client1
Visited_Client2
URL_AddressOffline
URL_AddressOnline
URL_String

Methods:

| | |
|---|---|
| Method: | SplashScreen (IsSplash, hI, * MediaTitles, URL Link) |
| Input: | As above |
| Output: | None |
| Description: | Splash Screen Class constructor |
| Pseudocode: | Store MediaTitles |
| | Initialise ThisSplashScreen |
| | Initialise TheWindow |
| | Initialise Replay |
| | Store IsSplash |
| | Store hI |
| | Initialise NoListBox |
| | Initialise OldCursor |
| | Initialise OldCursorValid |
| | Initialise URLFont |
| | Initialise Visited_Egenie |
| | Initialise Visited_Client1 |
| | Initialise Visited_Client2 |
| | Initialise URL_AddressOnline |
| | Initialise URL_AddressOffline |
| | Initialise URL_String |
| | Parse the URL Link and separate into components. |

| | |
|---|---|
| Method: | ˜SplashScreen ( ) |
| Input: | None |
| Output: | None |
| Description: | SplashScreen destructor class, frees all memory |
| | used by |
| | SplashScreen |
| Pseudocode: | Ends dialog if necessary |
| | Delete fonts |
| | Delete new strings |

| | |
|---|---|
| Method: | IsMouseOverWindow (This Window) |
| Input: | A window |
| Output: | boolean |
| Description: | Returns true or false, if a mouse is over a window. |
| Pseudocode: | Get Cursor point |
| | Check if inside window bounds |
| | Return true if so, else return false |

| | |
|---|---|
| Method: | int Show ( ) |
| Input: | HWnd - Parent, In SingleTrack |
| Output: | int |
| Description: | Creates the dialog as required.. |
| Pseudocode: | Store In_SingleTrack |

Start Timer
If it is a splash screen then

Create the dialog (modeless)
Process all pending messages.

Else if

Create the dialog (Modal)

End if
return

| | |
|---|---|
| Method: | MainDlgProc ( ) |
| Input: | Standard Windows Processing |
| Output: | boolean |
| Description: | Processes all splash screen window handling. |
| Pseudocode: | In case of particular message do, |

If first starting

Call init dialog

End If
If colour type request

If URL text, highlight as required and
make background
transparent

End If
If mouse move

Check if a URL object is being passed over.
If so, set cursor to a hand.
If not set to default cursor

End If
If setting cursor is required.

Set cursor according to function above.

End If
If Left Button Down

Check if link has been pressed, if so
Get details of current program, application
name, drive letter
Call HttpCheck and find if user is online.
Jump to Online URL if online
Jump to Offline URL if offline.

End If
If Command then

If cancel

End Dialog

End If
If replay

Set correct exit code
End Dialog

End If
If track selection

If double click, set exit code, and
close dialog

End If

End If
Default - return ok

End case

| | |
|---|---|
| Method: | OnInitDialog ( ) |
| Input: | None |
| Output: | None |
| Description: | Initialises all class variables for the dialog. |
| Pseudocode: | If it is the end dialog then |

Centre the window
Populate the track selection box
Hide it if single track, or track and logo
Create the font for the URLs
And attach to dialog box

End If
Return ok

| Method: | int Wait ( ) |
|---|---|
| Input: | Milliseconds |
| Output: | Int |
| Description: | Waitis a certain number of milliseconds |
| | before continuing. |
| Pseudocode: | If time hasn't expired, the sleep for the |
| | remaining time. |
| Method: | URL_Encode (InBuffer, OutBuffer) |
| Input: | As above |
| Output: | boolean |
| Description: | Encode a string for URL usage. |
| Pseudocode: | Parse the input buffer, and return details to |
| | the output buffer. |

| | |
|---|---|
| Method: | int HttpCheck ( ) |
| Input: | DNS name to ping |
| Output: | int |
| Description: | Determines if the online URL web site is available. |
| Pseudocode: | Open Windows socket system |
| | If error return Internet Unavailable |
| | Look up domain name to obtain IP address |
| | If error return Internet Unavailable |
| | Attempt connection to server at port 80 |
| | If error return Internet Unavailable |
| | Return Internet OK |

Program Name;

Main Windows Start Up function

Description:

Displays the starting screen and the ending screen for the application.

Global Variables:

URL Link
Playback class
Accelerator Interface
Splash Screen Class

Functions:

| | |
|---|---|
| Method: | WindowProc ( ) |
| Input: | Window Messaging Call back variables. |
| Output: | long |
| Description: | Main Window default message handler |
| Pseudocode: | If the playback doesn't exist, don't process |
| | the messages. |
| | Else pass to playback class.. |

| Method: | WinMain ( ) |
|---|---|
| input: | Window Application variables. |
| Output: | int |
| Description: | Main Program |
| Pseudocode: | Initialise running variables. |
| | Increase the process priority to be higher than |
| | director |
| | Set error mode for the program to catch critical |
| | errors |
| | Call Handle the command line if fails, exit program |
| | Complete setting up of variables. |
| | Call InitApplication if failed exit program |
| | If a splash screen is required, |

Create splash screen

If error then exit program

Show splash screen

End If
RERUN:
If Playback class doesn't exit

Create new playback with command
line variables

End If
Open the playback.
If error, exit program
If a splash screen is required.

Wait for 3 seconds
Delete the splash screen

End If
Start Windows Message Processing loop.

If message

get message.
Translate accelerated message
Dispatch Message
If playback failed, exit loop

Else If

If app active and visible

If failed exit loop
Play a frame
If error exit loop
Check threads are healthy
If error exit loop
If video finished, prepare
for next track and exit

loop.

Else If

If waiting while track
changing

Check if track
changing timer has

finished.

If so jump to
next track (or
continue)

Else If

Wait for next
windows message.

End If

End If

End If

End loop
If changing track then go to rerun
Delete the playback structure
If an execute string is present, execute it and exit
If the end dialog is required

Create the end screen
Run the end screen
If return result is error, exit program
If rerun, jump to rerun
If rerun clip rerun that clip.

| | End If |
|---|---|
| | Clean up allocated variables and exit program. |
| Method: | HandleCommandLine ( ) |
| Input: | Command line variables |
| Output: | int |
| Description: | Handle the command line variables |
| Pseudocode: | Parse the command line execute with the program. Convert |
| | to upper case for |
| | switch options, and collect the following details: |
| | (all optional) |
| | /quality - is a performance message required. |
| | /nosplash - is no splash screen required |
| | /noend - is no end dialog required |
| | /singletrack - play one track, and one track only |
| | /url - pick up message, online URL string and Offline |
| | URL string. |
| | /run - execute this program when finished |
| | /window - don't play full screen, but in a window |
| | /size xxx × yyy - required screen display resolution. |
| | /track - which video clip to play |

| | |
|---|---|
| Method: | InitApplication ( ) |
| Input: | HINSTANCE. |
| Output: | int |
| Description: | Application registering for windows |
| Pseudocode: | Create and register a windows class for this application. |
| | Load short cut accelerators |
| | Return success |

Although the salient features, functions and arrangements of the an implementation of the present invention have been presented hereinabove, the description is not exhaustive, and those of ordinary skill in the art will recognise that many modifications and additions can be made to what has been described without departing from the spirit and scope of the present invention. Accordingly, the present invention is intended to embrace all such alternatives, modifications and variations that fall within the spirit and broadest scope of the appended claims. All publications, patents and patent applications mentioned in this specification are herein incorporated in their entirety by reference into the specification, to the same extent as if each individual publication, patent and patent application was specifically and individually indicated to be incorporated herein by reference. In addition, citation or identification of any reference in this application shall not be construed as an admission that such reference is available as prior art to the present invention. Further, citation or identification of any reference in this application shall not be construed as an admission that any disclosure therein constitutes, or would be considered by an ordinarily skilled artisan in the field of the invention to constitute, common and/or general knowledge in the field.

Throughout this specification, unless the context requires otherwise, the sword “comprise”, or variations such as “comprises” or “comprising”, will be understood to imply the inclusion of a stated integer or group of integers but not the exclusion of any other integer or group of integers. Furthermore, the foregoing detailed description of an implementation of the invention has been presented by way of example only, and is not intended to be considered limiting to the invention which is defined in tie claims appended hereto.

1. A method for providing multimedia presentation by way of a computer processing and display apparatus having a data reading device for reading data from a removable digital data storage carrier, such as an optical data storage disk or the like, wherein a removable data storage carrier is provided having stored thereon at least one multimedia content data file in a compressed format, together with computer program code for execution on the computer processing and display apparatus and adapted for decompression of the at least one multimedia content data file and presentation of the multimedia content on the computer processing and display apparatus, wherein the computer program code provided with the multimedia content data file on the removable data storage carrier includes a data decompression module adapted to decompress the associated multimedia content data file and a multimedia player module that receives decompressed data from the decompression module and presents corresponding multimedia content for output by way of the computer apparatus hardware, whereby the multimedia content of the associated data file is presented by the computer apparatus hardware through use of the computer, program code upon insertion of the removable data storage carrier in the data reading device and execution of the computer program code, and wherein the decompression and player program code modules are executable on the computer processing and display apparatus without requiring installation with the computer operating system, the player program module adapted to effect presentation of the associated multimedia content without reference to the operating system registry.

2. A method as claimed in claim 1, wherein the multimedia content includes moving pictures video and audio.

3. A method as claimed in claim 2, wherein the multimedia presentation comprises substantially full-screen broadcast quality video.

4. A method as claimed in claim 1, wherein the multimedia presentation is initiated automatically upon insertion of the removable data storage carrier in the computer data reading device.

5. A method as claimed in claim 1, wherein the player program module interacts directly with the decompression module and a hardware abstraction layer of the computer operating system in order to provide the multimedia content presentation.

6. A method as claimed in claim 5, wherein the computer operating system comprises a Microsoft Windows™ operating system.

7. A method as claimed in claim 1, wherein the at least one multimedia content data file is encoded with a digital key or the like, such that decompression and/or playing of the multimedia content is only possible utilising decompression and/or player program modules provided with a corresponding decoding key.

8. A method as claimed in claim 7, wherein the decoding key is provided on the removable data storage carrier.

9. A method as claimed in claim 7, wherein the decoding key is provided separately for input to the computer apparatus by a user to enable presentation of the multimedia content.

10. A method as claimed in claim 9, wherein the decoding key is provided with packaging associated with distribution of the removable data storage carrier.

11. A method as claimed in claim 7, wherein the decoding key is provided to the computer apparatus by way of a digital communications network, such as the internet or a corporate intranet.

12. A method as claimed in claim 11, wherein the decoding key is transmitted to the computer apparatus from an authorisation server in response to information provided by a user.

13. A method as claimed in claim 12, wherein the user provides information for initiation of an electronic commerce transaction, in response to which the decoding key is transmitted.

14. A method as claimed in claim 7, wherein the validity of the decoding key is time limited, whereby presentation of the multimedia content with the decoding key is only possible over a predetermined time period.

15. A method as claimed in claim 7, wherein the validity of the decoding key is limited to a predetermined number of instances of the multimedia content presentation.

16. A method as claimed in claim 2, wherein the video display presentation includes at least one display region that is user selectable by way of a pointing device, such as a computer mouse or the like, to cause the player program module to perform at least one corresponding predetermined action.

17. A method as claimed in claim 16, wherein the at least one corresponding predetermined action relates to control of the video playback presentation.

18. A method as claimed in claim 16, wherein the at least one corresponding predetermined action comprises presentation of information obtained by way a digital communications network transmitted to the computer apparatus in response to the user selection,

19. A method as claimed in claim 1, wherein the removable data storage carrier comprises a computer readable compact disc (CD-ROM),

20. A method as claimed in claim 1, wherein the multimedia content data file is compressed according to MPEG-4 encoding.

21. A computer readable, removable digital data storage carrier having stored thereon at least one multimedia content data file in a compressed format together with computer program code for execution on a computer processing and display apparatus to decompress the at least one multimedia content data file and present the multimedia content on the computer processing and display apparatus, wherein the computer program code provided with the multimedia content data file on the removable data storage carrier includes a data decompression module adapted to decompress the associated multimedia content data file and a multimedia player module that, during execution on the computer apparatus, receives decompressed data from the decompression module and presents corresponding multimedia content for output by way of the computer apparatus hardware, whereby the multimedia content of the associated data file is presented by the computer apparatus hardware through use of the computer program code upon insertion of the removable data storage carrier in the data reading device and execution of the computer program code, wherein the decompression and player program code modules are executable on the computer processing and display apparatus without requiring installation with the computer operating system and wherein the player program module is adapted to effect presentation of the associated multimedia content without reference to the operating system registry.

22. A computer readable, removable digital data storage carrier as claimed in claim 21, wherein the player program module is adapted to interact, during execution, directly with the decompression module and a hardware abstraction layer of the computer operating system in order to provide the multimedia content presentation.

23. A computer readable, removable digital data storage carrier as claimed in claim 21, wherein the computer operating system is a Microsoft Windows™ operating system.

24. A computer readable, removable digital data storage carrier as claimed in claim 21, wherein the at least one multimedia content data file is encoded with a digital key or the like, such that decompression and/or playing of the multimedia content is only possible utilising decompression and/or player program modules provided with a corresponding decoding key.

25. A computer readable, removable digital data storage carrier as claimed in claim 24, wherein the decoding key is provided stored on the removable data storage carrier.

26. A computer readable, removable digital data storage carrier as claimed in claim 24, distributed with packaging providing said decoding key.

27. A computer readable, removable digital data storage carrier as claimed in claim 21, wherein the removable data storage carrier comprises a computer readable compact disc (CD-ROM).

28. A computer readable, removable digital data storage carrier as claimed in claim 21, wherein the multimedia content data file is compressed according to MPEG-4 encoding.

29. A computer having multimedia presentation capabilities operating under control of an operating system, in combination with a computer program that is executable on said computer to provide a multimedia presentation using an associated encoded media data file without requiring installation of the computer program with the operating system, the computer program including a decompression program module for decompressing media data from the encoded media data file and a player program module that in use interacts directly with the decompression module and a hardware abstraction layer of the computer operating system in order to provide the multimedia content presentation, wherein the player program module is adapted to effect presentation of the associated multimedia content without reference to the operating system registry.

30. The combination of claim 29, wherein the computer operating system comprises a Microsoft Windows™ operating system.

31. The combination of claim 29, wherein the multimedia presentation comprises substantially full-screen broadcast quality video.

32. The combination of claim 31, wherein the computer program is provided stored on a removable data storage carrier, such as an optical digital storage disk or the like, together with at least one associated encoded media data file.

33. A computer program in machine readable form and executable on a computer operating under control of an operating system, the computer program including a decoding program module for decoding media data from an associated encoded media data file, and a player program module for processing the decoded media data and controlling the computer to provide a video display presentation of the decoded media data, wherein the computer program is executable without requiring installation under the computer operating system, and the player program module is adapted to effect presentation of the media data without reference to the operating system registry.

34. A computer program as claimed in claim 33, including at least one encoded media data file.

35. A computer program as claimed in claim 34, wherein at least one corresponding digital key is required by the decoding program module in order to effect decoding of each encoded media data file.

36. A computer program as claimed in claim 35, including a user input function by which a user may provide a digital key to enable decoding of an encoded media data file and subsequent playback of the corresponding video display presentation.

37. A computer program as claimed in claim 35, including a communications program module by which the computer program may receive, by way of a digital communications network, a digital key to enable decoding of an encoded media data file and subsequent playback of the corresponding video display presentation.

38. A computer program as claimed in claim 34, wherein the computer program executable modules and at least one encoded media data file are stored for distribution on a removable digital data storage carrier, such as a computer readable compact disk or the like.
